(19) United States
(12) Patent Application Publication
(10) Pub. No.: US 2024/0084461 A1
(43) Pub. Date: Mar. 14, 2024

(54) Method for Preparing Lithium Hydroxide, and Facility for Implementing the Method

(71) Applicants: Eurodia Industrie, Pertuis (FR); France Evaporation, Noyelle-Les-Seclin (FR)

(72) Inventors: Anne GONIN, Pertuis (FR); Florence LUTIN, PERTUIS (FR); Arnaud CARDINEAUD, Lille (FR)

(73) Assignees: Eurodia Industrie, Pertuis (FR); France Evaporation, Noyelle-Les-Seclin (FR)

(21) Appl. No.: 18/463,089

(22) Filed: Sep. 7, 2023

(30) Foreign Application Priority Data
Sep. 8, 2022 (FR) 2208978

(51) Int. Cl. C25B 1/16; C25B 9/21; C25B 15/031

(52) U.S. Cl. CPC C25B 1/16; C25B 9/21; C25B 15/031

(57) ABSTRACT

The present invention relates to a method for preparing lithium hydroxide, comprising subjecting an aqueous composition (A), comprising lithium sulfate and sodium sulfate, to bipolar membrane electrodialysis; said step of bipolar membrane electrodialysis comprises processing in an electrodialyser comprising at least one electrodialysis cell (200) comprising a first compartment (220), supplied with water and delimited between a first bipolar membrane (250) and an anionic central membrane (230), and a second compartment (210), supplied with said aqueous composition (A) and delimited between said anionic central membrane (230) and a second bipolar membrane (240), then recovering, from said at least one electrodialysis cell (200), an aqueous composition (B) comprising lithium hydroxide and sodium sulfate, and subjecting it to a crystallisation step in order to prepare a salt.

### TECHNICAL FIELD

The present invention relates to a method for preparing lithium hydroxide, and a facility for implementing the method.

### BACKGROUND

Lithium hydroxide is used in many applications, for example in respiratory gas purification systems for spacecraft, submarines and rebreathers in order to remove carbon dioxide from exhaled gases by producing lithium carbonate and water, or else as a heat transfer fluid or as an electrolyte for batteries, in particular motor vehicle batteries.

However, lithium is not found naturally in metallic form because it is highly reactive. Lithium must thus be extracted and purified from the support with which it is combined. Lithium can be extracted by leaching from igneous rocks (for example spodumene-type silicate) and to a lesser extent from granite, but also from clays or from brine reservoirs naturally rich in lithium, sodium and potassium salts, located under the bed of salt lakes (salars). Lithium may be present in certain groundwaters; the geothermal industry is particularly interested in this. Lithium can also be recycled from a used and manufactured support incorporating lithium, or from aqueous effluents comprising lithium and resulting from lithium transformation processes.

The resulting lithium salts are used, for example, as raw materials for synthesis of cathode materials or as salts in the electrolytes of lithium batteries.

There is therefore a need to propose methods for isolating/separating lithium, minimising lithium losses and aiming to produce lithium with as few impurities as possible.

EP 3 326 974 A1 discloses a method for preparing lithium hydroxide and lithium carbonate, comprising a step of processing an aqueous composition comprising lithium sulfate and sodium sulfate by means of a bipolar membrane electrodialysis with three compartments comprising cationic and anionic membranes in order to obtain an aqueous composition comprising lithium hydroxide mixed with potassium hydroxide and sodium hydroxide. In this method, when this mixed aqueous composition is concentrated, first the lithium hydroxide (LiOH) and then the sodium hydroxide (NaOH) become saturated, and then a “mixed” salt which contains lithium and sodium forms. It is impossible to then isolate the lithium in this salt. The solid lithium hydroxide obtained will therefore have a low purity.

Methods are also known for separating lithium from salts formed with sodium and potassium, comprising precipitating lithium with carbonate in order to form lithium carbonate. These methods involve a prior step of concentrating the lithium by evaporation before its precipitation in carbonate form, because lithium carbonate (Li2CO3) is not very soluble in water. In certain cases, lithium carbonate is precipitated at high temperature because its solubility in water is inversely proportional to the temperature, whereas that of sodium carbonate remains very high between 40° C. and 100° C. These methods therefore involve a large consumption of energy and above all of chemicals and can lead to the production of by-products (NaCl, Na2SO4 for example).

There is a need for a method for preparing lithium hydroxide, in particular lithium hydroxide monohydrate, limiting the consumption of reagents (sodium hydroxide or sodium carbonate, for example) and saline discharges, or enabling the recovery of sulfuric acid in the overall circuit for lithium hydroxide production, while minimising saline discharges.

There is also a need for a method for preparing lithium hydroxide having a high degree of purity, while providing a method for reproducible and reliable preparation.

### SUMMARY OF THE INVENTION

The present invention overcomes all or part of the above-mentioned problems in that it has as object, according to a first aspect, a method for preparing lithium hydroxide comprising the steps:
a) subjecting an aqueous composition (A) comprising lithium sulfate and sodium sulfate, to a bipolar membrane electrodialysis (BPED1) in order to convert at least a part, or substantially all, of the lithium sulfate into lithium hydroxide, in particular retaining the sodium sulfate salts;
said step a) of bipolar membrane electrodialysis (BPED1) comprising processing in an electrodialyser comprising at least one electrodialysis cell, said electrodialysis cell comprising:
   a first compartment in which water is supplied, in particular at the inlet of the first compartment, between a first bipolar membrane and an anionic membrane, in particular an anionic central membrane, and
   a second compartment in which said aqueous composition (A) comprising lithium sulfate and sodium sulfate is supplied, in particular at the inlet of the second compartment, between an anionic membrane, in particular said anionic central membrane, and a second bipolar membrane,
b) recovering an aqueous composition (B) comprising lithium hydroxide and sodium sulfate at the outlet of the second compartment of said at least one electrodialysis cell,
c) subjecting at least a part of the aqueous composition (B) comprising lithium hydroxide and sodium sulfate to a crystallisation step of a salt, in particular a lithium hydroxide salt or a sodium sulfate salt.

Advantageously, the bipolar electrodialysis (BPED1) is an anionic, two-compartment bipolar electrodialysis, for extracting excess sulfate ions SO₄²⁻ which can be combined with Li⁺ ions or with Na ions, and producing lithium hydroxide LiOH mixed with sodium sulfate Na₂SO₄.

Said at least one electrodialysis cell of the electrodialyser of step b) (BPED1) preferably substantially consists of (in particular each of the stacked electrodialysis cells of the electrodialyser of step b) (BPED1) substantially consists of) said first and second compartments separated by the anionic central membrane.

Advantageously, the first compartment is delimited between the first bipolar membrane and the anionic central membrane.

Advantageously, the second compartment is delimited between the anionic central membrane and the second bipolar membrane.

Advantageously, said at least one cell is a structural unit repeated several times in order to form a stack of cells in the bipolar electrodialyser (BPED1).

Advantageously, the first bipolar membrane of the first compartment comprises an anionic face oriented towards the anode and a cationic face oriented towards the cathode and towards said anionic central membrane.

Advantageously, the second bipolar membrane of the second compartment comprises an anionic face oriented towards the anode and towards the anionic central membrane, and comprises a cationic face oriented towards the cathode.

A (so-called) bipolar membrane may be, for example, an assembly of two membranes: an anionic membrane and a cationic membrane.

A (so-called) bipolar membrane may be, for example, a cationic membrane comprising anionic exchangers grafted onto one of its two faces or an anionic membrane comprising cationic exchangers grafted onto one of its two faces.

In the present text, “anionic membrane” is understood to mean any membrane allowing the passage of (monovalent and/or multivalent) anions, and therefore not allowing the passage of cations, and “cationic membrane” is understood to mean any membrane allowing the passage of (monovalent and/or multivalent) cations, and therefore not allowing the passage of anions.

The bipolar electrodialysis device (BPED1) comprises a plurality of cells similar to said at least one cell defined above, in particular at least 5 cells, more particularly 25 cells, preferably from approximately 25 cells to approximately 400 cells.

Advantageously, the bipolar electrodialysis device comprises an anode and a cathode disposed on either side of a stack of cells (comprising, for example, from approximately 25 cells to approximately 400 cells).

Advantageously, the anionic central membrane of said at least one cell is an anionic exchange membrane of monovalent and/or multivalent anions.

In an embodiment, the aqueous composition (A) comprising lithium sulfate and sodium sulfate of step a) has a mass content of multivalent cations, in particular divalent cations, less than or equal to 5 ppm (or to 5 mg of cations/kg of composition (A)). Said mass content is calculated with respect to the total mass of the aqueous composition (A) including water.

In the present text, 1 ppm is equal to 1 mg/kg.

In an embodiment, the aqueous composition (A) of step a) results from a method of purification and concentration of lithium salt, in particular lithium sulfate.

In an embodiment, the aqueous composition (A) comprising lithium sulfate, and sodium sulfate of step a), or supplied to the second compartment of said at least one cell of the BPED1, comprises (or substantially consists of) one or more aqueous solutions selected from the list comprising: a solution for extracting lithium dissolved in seawater, brines comprising lithium, for example salars, or geothermal fluid comprising lithium, a solution resulting from a method for recycling a lithium battery, a solution resulting from the treatment of spodumene, or a mixture thereof.

In an embodiment, the water supplied to the first compartment of said at least one electrodialysis cell of the electrodialyser of the BPED1 is demineralised water, or osmosis-purified water, or softened water or results from the condensation of vapours from the crystallisation step by evaporation c), or results from a mixture thereof.

In an embodiment, the temperature of the water supplied to the first compartment of said at least one electrodialysis cell of the electrodialyser of the BPED1 is greater than or equal to 5° C. and less than or equal to 65° C., in particular is substantially equal to the ambient temperature, more particularly is greater than or equal to approximately 15° C. and less than or equal to approximately 50° C. or 40° C.

Preferably, the pH of the water fed to the first compartment of said at least one electrodialysis cell of the EDBP1 electrodialyser, particularly prior to the extraction of sulphate ions, is greater than or equal to 5 and less than or equal to 7.5.

In an embodiment, the temperature of the aqueous composition (A) comprising lithium sulfate and sodium sulfate supplied to the second compartment of said at least one electrodialysis cell of the electrodialyser of BPED1 is greater than or equal to 5° C. and less than or equal to 65° C., in particular is substantially equal to the ambient temperature, more particularly is greater than or equal to approximately 15° C. and less than or equal to 50° C. or 40° C.

Advantageously, the aqueous composition (A) comprises lithium sulphate, sodium sulphate and optionally lithium hydroxide and/or sodium hydroxide (particularly in small quantities). Preferably, the mass fraction of lithium sulphate and sodium sulphate measured on the dry extract by mass of the aqueous composition (A) is greater than or equal to 80%, more preferably greater than or equal to 90%, even more preferably greater than or equal to 95%.

Advantageously, the crystallisation step c) is a separation step allowing the formation of a salt, in particular lithium hydroxide or sodium sulphate, on the one hand, and the formation of a liquor on the other hand, in particular enriched with sodium sulphate or lithium hydroxide (depending on the salt extracted in parallel). Advantageously, the crystallised salt is the majority component in the aqueous composition (B).

In an alternative embodiment, the aqueous composition (A), comprising lithium sulfate and sodium sulfate supplied at the inlet of the second compartment of said at least one electrodialysis cell of the bipolar membrane electrodialyser (BPED1) in step a), has a pH greater than or equal to 4 and less than or equal to 11, preferably less than or equal to 10.5, more preferably less than or equal to 10, even more preferably greater than or equal to 5 or 6, and optionally less than or equal to 8.

In an alternative embodiment, the aqueous composition (B), comprising lithium hydroxide and sodium sulfate at the outlet of the second compartment of said at least one electrodialysis cell of the bipolar membrane electrodialyser (BPED1) in step a), in particular of the electrodialyser of BPED1, has a pH greater than or equal to 9, preferably greater than or equal to 10, more preferably greater than or equal to 11.

Advantageously, the step a) (BPED1) increases the pH of the aqueous composition (A) of step a) because the hydroxyl OH⁻ ions accumulate in the second compartment and form LiOH and the protons H⁺ mostly remain in the first compartment and form H₂SO₄. In one embodiment, the conductivity (mS/cm) of the aqueous composition (A) fed to the inlet of the second compartment of the electrodialyzer (EDBP1) of step a) is greater than or equal to 50 mS/cm.

In an alternative embodiment, the conductivity (mS/cm) of the aqueous composition (B) at the outlet of the second compartment of the electrodialyzer (EDBP1) of step a) is greater than the conductivity of the aqueous composition (A) at the inlet of the second compartment of the said electrodialyzer (EDBP1) of step a), preferably greater than or equal to 100 mS/cm, more preferably greater than or equal to 150 mS/cm.

In an alternative embodiment, the aqueous composition at the outlet of the first compartment of said at least one electrodialysis cell of the bipolar membrane electrodialyser (BPED1) in step a) comprises sulfuric acid, preferably said aqueous composition has a pH less than or equal to 2, more preferably less than or equal to 1.

Preferably, this acid can be recovered or reused in other process lines, notably in the method according to the invention.

In an alternative embodiment, the aqueous composition at the outlet of the first compartment of said at least one electrodialysis cell of the bipolar membrane electrodialyser (BPED1) in step a) comprises sulfuric acid with a mass concentration (g/liter) greater than or equal to 1% and less than or equal to 12%, in particular less than or equal to 10%, optionally greater than or equal to 2% or 4% or 6% or 8%.

In the present text, it is understood by mass concentration of sulphuric acid of x % in a given aqueous composition that this aqueous composition comprises x g of sulphuric acid per 100 g of aqueous composition comprising the said sulphuric acid. In an embodiment, the aqueous composition at the outlet of the first compartment of said at least one electrodialysis cell of the bipolar membrane electrodialyser (BPED1) in step a) comprises sulfuric acid at a mass concentration greater than or equal to 1% and less than or equal to 4%.

In an alternative embodiment, the mass (g) ratio of lithium ions and sodium ions over the total mass (g) of cations in the aqueous composition (A), comprising lithium sulfate and sodium sulfate and supplied at the inlet of the second compartment of said at least one electrodialysis cell of the bipolar membrane electrodialyser (BPED1) in step a), is greater than or equal to 95%.

In one embodiment, the ratio of the mass (g) of lithium ions and sodium ions to the total dry mass (g) of the aqueous composition (A), comprising lithium sulphate and sodium sulphate and fed to the inlet of the second compartment of the said at least one electrodialysis cell of the bipolar membrane electrodialyser (EDBP1) in step a), is greater than or equal to 80%, preferably greater than or equal to 90%, even more preferably greater than or equal to 95%.

In an alternative embodiment, the mass ratio (g/g) between the lithium ions and sodium ions (Li/Na) in the aqueous composition (A), comprising lithium sulfate and sodium sulfate and supplied at the inlet of the second compartment of said at least one electrodialysis cell of the bipolar membrane electrodialyser (BPED1) in step a), is greater than or equal to 0.1 and less than or equal to 9, preferably greater than or equal to 0.4 and less than or equal to 2.3; more preferably greater than or equal to 0.66 and less than or equal to 1.5, preferably greater than or equal to 0.8 and less than or equal to 1.3; more preferably greater than or equal to 0.8 and less than or equal to 1.2; in particular greater than or equal to 0.9 and less than or equal to 1.1; more particularly greater than or equal to 0.95 and less than or equal to 1.05.

In an alternative embodiment, the mass (g) ratio of sulfate ions (SO₄²⁻) and hydroxyl ions (OH⁻), with respect to the total mass (g) of anions in the aqueous composition (A), comprising lithium sulfate and sodium sulfate and supplied at the inlet of the second compartment of said at least one electrodialysis cell of the bipolar membrane electrodialyser (BPED1) in step a), is greater than or equal to 95%.

In one embodiment, the ratio of the mass (g) of sulphate ions (SO₄²⁻) and hydroxyl ions (OH⁻) to the total dry mass (g) of the aqueous composition (A), comprising lithium sulphate and sodium sulphate and fed to the inlet of the second compartment of the said at least one electrodialysis cell of the bipolar membrane electrodialyser (EDBP1) in step a), is greater than or equal to 80%, preferably greater than or equal to 90%, even more preferably greater than or equal to 95%.

The mass fractions of ions are calculated in the present text with respect to the total dry mass of the composition (A) of step a) or the total mass of anions or cations of the composition (A) of step a).

The mass fractions of lithium ions and sodium ions, and of sulfate ions, mentioned above, advantageously allow a BPED1 with two anionic compartments to be carried out.

In an alternative embodiment, the aqueous composition (A) comprising lithium sulfate and sodium sulfate and supplied to the second compartment of said at least one electrodialysis cell of the bipolar membrane electrodialyser (BPED1) in step a) has a mass dry extract greater than or equal to 2% and less than or equal to 20%, in particular less than or equal to 15%, more particularly greater than or equal to 5%.

In an alternative embodiment, the mass ratio between the lithium ions and sodium ions (Li/Na) in the aqueous composition (B), coming from the second compartment of said at least one electrodialysis cell of the bipolar membrane electrodialyser (BPED1) in step a), is similar (specifically to within +/−10%) to the mass ratio between the lithium ions and sodium ions (Li/Na) of the aqueous composition (A) supplied at the inlet of the second compartment of said at least one electrodialysis cell of the bipolar membrane electrodialyser (BPED1) in step a).

Indeed, the lithium and sodium ions are not extracted from the aqueous composition (A) during the electrodialysis of step a) (BPED1).

In an alternative embodiment, the current density (mA/cm²) applied in the bipolar membrane electrodialysis step (EDBP1) in step a), or in the bipolar membrane electrodialysis step (EDBP2) (in particular described below), is greater than or equal to 50 mA/cm² and less than or equal to 100 mA/cm², in particular greater than or equal to 60 mA/cm² and less than or equal to 90 mA/cm².

This is the amount of current (A) applied per surface area (cm²) of ion exchange membrane.

In an alternative embodiment, the quantity of sulfate ions extracted from the composition (A) in step a) is approximately equal to the quantity, in molar equivalent, of lithium ions present in solution in said composition (A), for example 1 mole of extracted sulfate ions corresponds to 2 moles of lithium ions released and potentially complexed by the hydroxyl ions.

In an alternative embodiment, the crystallisation step c) of a salt is a crystallisation step, in particular by evaporation, of a lithium hydroxide salt in order to obtain a lithium hydroxide salt on the one hand, and a mother liquor (I) comprising sodium sulfate and lithium hydroxide on the other hand.

Preferably, in this case, the mass ratio (g/g) Li/Na is high in the composition (A), in particular greater than or equal to 0.8, more particularly greater than or equal to 0.9 or 1.

When the mass concentration of lithium is approximately equivalent to, or greater than, the mass concentration of sodium in the composition (B), it is advantageously possible to start with a crystallisation by evaporation in order to form an impure solid lithium hydroxide salt.

In an embodiment, the crystallisation step by evaporation c) is carried out by heating the aqueous composition (B) to a temperature greater than or equal to 30° C., more particularly less than or equal to 110° C., for example ranging from 50° C. to 70° C., until a solid lithium hydroxide salt is obtained.

Advantageously, the mother liquor (I) obtained in the crystallisation step by evaporation c) has a mass concentration of sodium sulfates greater than or equal to 5% and less than or equal to 30%, preferably greater than or equal to 8% and less than or equal to 25%, more preferably greater than or equal to 10% and less than or equal to 20%, preferably less than or equal to 18%, in particular less than or equal to 16%.

Advantageously, the mother liquor (I) obtained in the crystallisation step by evaporation c) has a mass concentration of lithium hydroxide (LiOH) greater than or equal to 3% and less than or equal to 20%, preferably greater than or equal to 5% and less than or equal to 15%, more preferably greater than or equal to 6% and less than or equal to 10%.

The mass concentrations are calculated by relating the dry mass of sodium sulfates or lithium hydroxide to the total mass of the mother liquor (I) (in particular including water).

In an alternative, said method comprises a step d) of dissolving at least a part of the lithium hydroxide salt obtained in step c) in order to form an aqueous composition (C) comprising said dissolved lithium hydroxide salt, and said method further comprises a crystallisation step e), in particular by evaporation, of at least a part of the aqueous composition (C) in order to obtain lithium hydroxide crystals and, optionally, a mother liquor (II), in particular said lithium hydroxide crystals undergo a drying step f), more particularly in order to obtain lithium hydroxide monohydrate crystals.

Preferably, the mother liquor (II) is rich in lithium hydroxide, and comprises traces of sodium sulfate.

Advantageously, the mother liquor (II) obtained in crystallisation step e) by evaporation has a mass concentration of lithium hydroxide (LiOH) greater than or equal to 6% and less than or equal to 30%, preferably greater than or equal to 8% and less than or equal to 25%, more preferably greater than or equal to 10% and less than or equal to 20%, in particular greater than or equal to 12% and less than or equal to 17%.

Advantageously, the mother liquor (II) obtained in crystallisation step e) by evaporation has a mass concentration of sodium sulfate less than or equal to 10%, preferably less than or equal to 8%, more preferably less than or equal to 6% or 4% or 3%, in particular less than or equal to 2%.

Advantageously, the step d) of dissolving said lithium hydroxide salt in water is carried out such that the mass concentration of lithium hydroxide is less than the solubility of LiOH.

Advantageously, the mass concentration of LiOH in the aqueous composition (C) prepared during dissolution step d) is greater than or equal to 1% and less than or equal to 15%, preferably less than or equal to 12%, more preferably less than or equal to 8%, in particular greater than or equal to 3%.

Advantageously, crystallisation step e), in particular by evaporation, comprises heating the aqueous composition (C), optionally following a drying step f), until lithium hydroxide monohydrate crystals (LiOH, H₂O) are obtained.

The mass concentrations are measured by relating the mass of sodium sulfate or LiOH to the total mass of the mother liquor (including water) or of the aqueous composition (including water) resulting from the dissolution.

The inventors have observed that the mother liquors which surround the lithium salt produced during the first crystallisation by evaporation c) are loaded with sodium sulfate (Na₂SO₄) which can harm the crystalline form of the crystals obtained. Moreover, these mother liquors contribute a non-negligible quantity of Na₂SO₄. The redissolving of the lithium hydroxide salt during the first dissolution d) makes it possible to generate a mother liquor (II) that is much less rich in Na₂SO₄ than the mother liquor (I) obtained during the first crystallisation by evaporation. Advantageously, the crystals obtained in the second crystallisation by evaporation e) are much purer. Performing a second crystallisation by evaporation e) therefore makes it possible to produce LiOH monohydrate crystals of high purity, and a mother liquor (II) depleted in sodium sulfate and therefore enriched in LiOH.

Advantageously, the lithium hydroxide monohydrate obtained has a purity greater than or equal to 95% or 97% or 98% or 99% or 99.5%.

The degree of purity is preferably evaluated with respect to the mass of LiOH monohydrate over the total mass of crystals obtained.

In an alternative embodiment, the crystallisation step by evaporation e) produces a mother liquor (II) comprising sodium sulfate and lithium hydroxide, at least a part of the mother liquor (II), optionally mixed with at least a part of the aqueous composition (B) comprising lithium hydroxide and sodium sulfate, is subjected to the first crystallisation by evaporation c).

In an alternative embodiment, said method comprises a crystallisation step g), in particular by cooling, of at least a part of the mother liquor (I) obtained in the crystallisation step c), in order to obtain a Glauber's salt and a mother liquor (III) comprising sodium sulfate and lithium hydroxide.

Advantageously, the crystallisation step by cooling g) comprises the application of a temperature greater than or equal to −20° C. and less than or equal to 25° C., more particularly a temperature greater than or equal to −10° C. and less than or equal to 15° C.

In the present text, “Glauber's salt” is understood to mean the sodium sulfate of formula (Na₂SO₄; 10H₂O).

Advantageously, the mother liquor (III) is depleted in sodium sulfate.

In an alternative embodiment, the crystallisation step c) of a salt is a crystallisation step, in particular by cooling, of a sodium sulfate salt (Na₂SO₄) in order to obtain a Glauber's salt on the one hand, and a mother liquor (III′) comprising lithium hydroxide and sodium sulfate on the other hand.

Preferably, in this case, the mass ratio Li/Na is low in the composition (A), in particular less than or equal to 0.8.

When the mass concentration of lithium is too low in the composition (A), it is advantageously possible to start with a crystallisation by cooling in order to form a sodium sulfate salt.

In an alternative embodiment, said method comprises:
a step h) or h′) of dissolving all or part of the Glauber's salt, in particular coming from the crystallisation step by cooling g) or c), so as to form an aqueous composition (D) or (D′) comprising sodium sulfate, and
processing j) or j′) at least a part of said aqueous composition (D) or (D′) comprising sodium sulfate by a bipolar membrane electrodialysis (BPED2), in order to extract sulfate ions, on the one hand, and to form sulfuric acid and extract sodium ions on the other hand and to form sodium hydroxide.

Advantageously, the bipolar membrane electrodialysis (BPED2) is carried out in an electrodialyser comprising at least one electrodialysis cell, said at least one electrodialysis cell comprises (in particular substantially consists of) three compartments, and comprises first and second bipolar membranes, a first anionic membrane and a first cationic membrane.

Advantageously, said at least one electrodialysis cell comprises (in particular substantially consists of):
a first compartment supplied with water circulating between a first bipolar membrane and an anionic membrane, in particular the first bipolar membrane has an anionic face oriented towards the anode of the electrodialyser, and a cationic face oriented towards the anionic membrane;
a second compartment supplied with the aqueous composition (D) or (D′) comprising sodium sulfate circulating between the anionic membrane and a cationic membrane; and
a third compartment supplied with water circulating between the cationic membrane and a second bipolar membrane; in particular the second bipolar membrane has an anionic face oriented towards the cationic membrane, and a cationic face oriented towards the cathode of the electrodialyser.

Advantageously, the second compartment is disposed between the first and third compartments.

Advantageously, the aqueous composition at the outlet of the first compartment comprises sulfuric acid, and the aqueous composition at the outlet of the third compartment comprises sodium hydroxide (NaOH).

Advantageously, the aqueous composition (D) or (D′) comprising sodium sulfate at the inlet of the second compartment of said at least one cell of the electrodialyser (BPED2) is depleted in sodium sulfate.

In an alternative, said method comprises:
a step of preparing an aqueous composition (D) or (D′) from all or part of the Glauber's salt, in particular a step of dissolution h) or h′) of all or part of the Glauber's salt so as to form an aqueous composition (D) or (D′) comprising sodium sulfate or a step of heating the Glauber's salt so as to form an aqueous composition (D) or (D′) comprising sodium sulfate, in particular in the form of a slurry of said Glauber's salt, and
a crystallisation step i) or i′), in particular by evaporation, of at least a part of said aqueous composition (D) or (D′) comprising sodium sulfate, in order to obtain an anhydrous sodium sulfate salt and a mother liquor IV) or IV′) comprising sodium sulfate, and optionally traces of lithium hydroxide, and said crystallisation step i) or i′) is optionally followed by a drying step k) or k′) of the sodium sulfate salt obtained in the crystallisation step i) or i′).

Advantageously, the crystallisation step by evaporation i) or i′) comprises heating the aqueous composition (D) or (D′) comprising sodium sulfate to a temperature greater than or equal to 50° C. and less than or equal to 110° C., preferably to a temperature greater than or equal to 60° C. and less than or equal to 90° C., for example of order 80° C.+/−5° C.

In an alternative embodiment, the crystallisation step by cooling g) or c) is carried out so as to produce a mother liquor (III) or (III′) comprising:
sodium sulfate, for which, in particular, the mass concentration (in particular calculated with respect to the total mass of the liqueur including water) is greater than or equal to 5%, and less than or equal to 30%, preferably greater than or equal to 8% or 10% and less than or equal to 25% or 20%, more preferably less than or equal to 16%; and/or
lithium hydroxide, for which, in particular, the mass concentration (in particular calculated with respect to the total mass of the liqueur including water) is greater than or equal to 3%, and less than or equal to 20%, preferably greater than or equal to 4% or 6% and less than or equal to 20% or 15%, more preferably less than or equal to 10%.

In an alternative embodiment, the aqueous composition (D) or (D′) comprising sodium sulfate obtained by dissolving at least a part of the Glauber's salt obtained in the crystallisation step c) or g), has a mass concentration of sodium sulfate (calculated, in particular, with respect to its total mass including water) greater than or equal to 10% and less than or equal to 40%, preferably greater than or equal to 20% and less than or equal to 35%, more preferably greater than or equal to 24% and less than or equal to 30%, in particular at a temperature ranging from 15° C. to 40° C., more particularly at a temperature ranging from 25° C. to 40° C., for example of order 35° C.+/−2° C.

Advantageously, the mass concentration of sodium sulfate in the composition (D) or (D′) is determined as a function of the temperature of the aqueous composition and in order to be less than the threshold solubility of sodium sulfate.

The aqueous composition (D) or (D′), prepared in this way by dissolving at least a part of the Glauber's salt, can undergo a bipolar membrane electrodialysis j) or j′) or a crystallisation by evaporation i) or i′) as described above.

In an alternative embodiment, the crystallisation step by evaporation i) or i′) is carried out so as to produce a mother liquor (IV) or (IV′) comprising:
sodium sulfate, for which, in particular, the mass concentration (in particular calculated with respect to the total mass of the liqueur including water) is greater than or equal to 15%, and less than or equal to 44%, preferably greater than or equal to 20% or 25% and less than or equal to 30%, for example of order 26%+/−2%; and
lithium hydroxide, for which, in particular, the mass concentration (in particular calculated with respect to the total mass of the liqueur including water) is less than or equal to 10% and preferably less than or equal to 5%, more preferably less than or equal to 3% or 2%.

In an alternative, at least a part of the mother liquor (III) or (III′) obtained in crystallisation step g) or c), in particular by cooling, of sodium sulfate Na₂SO₄, undergoes a crystallisation step, in particular by evaporation, of lithium hydroxide (LiOH), in particular it involves the crystallisation step c) (in particular as described above) or a crystallisation step c′), more particularly in order to obtain an (in particular impure) lithium hydroxide salt on the one hand and the mother liquor (I) (in particular as described above) or a mother liquor (I′) comprising sodium sulfate and lithium hydroxide on the other hand.

Preferably, in this case, the mass ratio Li/Na in the mother liquor III or III′ is high, in particular greater than or equal to 0.8, more particularly greater than or equal to 0.9 or 1.

In an embodiment, the crystallisation step by evaporation c′) is carried out by heating the mother liquor (III′) to a temperature greater than or equal to 30° C., more particularly less than or equal to 110° C., for example ranging from 50° C. to 70° C., until a solid lithium hydroxide salt is obtained.

Advantageously, the mother liquor (I′) obtained in the crystallisation step by evaporation c′) has a mass concentration of sodium sulfates greater than or equal to 5% and less than or equal to 30%, preferably greater than or equal to 8% and less than or equal to 25%, more preferably greater than or equal to 10% and less than or equal to 20%, preferably less than or equal to 18%, in particular less than or equal to 16%.

Advantageously, the mother liquor (I′) obtained in the crystallisation step by evaporation c′) has a mass concentration of lithium hydroxide (LiOH) greater than or equal to 3% and less than or equal to 20%, preferably greater than or equal to 5% and less than or equal to 15%, more preferably greater than or equal to 6% and less than or equal to 10%.

The mass concentrations are calculated by relating the dry mass of sodium sulfates or lithium hydroxide to the total mass of the mother liquor (I) (in particular including water).

In an alternative, said method comprises a step d′) of dissolving at least a part of the lithium hydroxide salt obtained in crystallisation step c′) in order to form an aqueous composition (C′) comprising said dissolved lithium hydroxide salt, and said method comprises a crystallisation step e′), in particular by evaporation, of at least a part of the aqueous composition (C′) in order to obtain lithium hydroxide crystals and, optionally, a mother liquor (II′), in particular said lithium hydroxide crystals undergo a drying step f′), more particularly in order to obtain lithium hydroxide monohydrate crystals.

Preferably, the mother liquor (II′) is rich in lithium hydroxide, and comprises traces of sodium sulfate.

Advantageously, the mother liquor (II′) obtained in crystallisation step e′) by evaporation has a mass concentration of lithium hydroxide (LiOH) greater than or equal to 6% and less than or equal to 30%, preferably greater than or equal to 8% and less than or equal to 25%, more preferably greater than or equal to 10% and less than or equal to 20%, in particular greater than or equal to 12% and less than or equal to 17%.

Advantageously, the mother liquor (II′) obtained in crystallisation step e′) by evaporation has a mass concentration of sodium sulfate less than or equal to 10%, preferably less than or equal to 8%, more preferably less than or equal to 6% or 4% or 3%, in particular less than or equal to 2%.

Advantageously, the step d′) of dissolving said lithium hydroxide salt in water is carried out such that the mass concentration of lithium hydroxide is less than the solubility of LiOH.

Advantageously, the mass concentration of LiOH in the aqueous composition (C′) prepared during dissolution step d′) is greater than or equal to 1% and less than or equal to 15%, preferably less than or equal to 12%, more preferably less than or equal to 8%, in particular greater than or equal to 3%.

Advantageously, crystallisation step e′), in particular by evaporation, comprises heating the aqueous composition (C′), optionally following a drying step f′), until lithium hydroxide monohydrate crystals (LiOH, H₂O) are obtained.

The mass concentrations are measured by relating the mass of sodium sulfate or LiOH to the total mass of the mother liquor (including water) or of the aqueous composition (including water) resulting from the dissolution.

The inventors have observed that the mother liquors which surround the lithium salt produced during the crystallisation by evaporation c′) are loaded with sodium sulfate (Na₂SO₄) which can harm the crystalline form of the crystals obtained. Moreover, these mother liquors contribute a non-negligible quantity of Na₂SO₄. The redissolving of the lithium hydroxide salt during the dissolution d′) makes it possible to generate a mother liquor (II′) that is much less rich in Na₂SO₄ than the mother liquor (I′) obtained during the crystallisation by evaporation c′). Advantageously, the crystals obtained in the crystallisation by evaporation e′) are much purer. Performing a second crystallisation by evaporation e′) therefore makes it possible to produce LiOH monohydrate crystals of high purity, and a mother liquor (II′) depleted in sodium sulfate and therefore enriched in LiOH.

Advantageously, the lithium hydroxide monohydrate obtained has a purity greater than or equal to 95% or 97% or 98% or 99% or 99.5%.

The degree of purity is preferably evaluated with respect to the mass of LiOH monohydrate over the total mass of crystals obtained.

In an alternative, at least a part of the mother liquor (IV) or (IV′) obtained in the crystallisation step i) or i′), in particular by evaporation, of at least a part of the aqueous composition (D) or (D′) coming at least in part from the dissolution of Glauber's salt, undergoes a crystallisation step g) or c), in particular by cooling, optionally mixed with at least a part of the aqueous composition (B).

In an alternative embodiment, at least a part of the Glauber's salt obtained in the crystallisation step by cooling c) or g) is heated, in particular to a temperature greater than or equal to 25° C., more particularly greater than or equal to 31° C.

Advantageously, a slurry of anhydrous sodium sulfate is obtained in a solution saturated with sodium sulfate.

Advantageously, during heating, the Glauber's salt releases its combined water, enabling the formation of said slurry. This step is referred to as the ‘Melt’.

Advantageously, said method comprises a crystallisation step by evaporation of said slurry in order to crystallise all of the sodium sulfate.

Nevertheless, this pathway is more delicate to implement in order to obtain beautiful sodium sulfate crystals.

In an alternative, at least a part of the mother liquor (I′), obtained in the crystallisation step by evaporation c′), is processed in the crystallisation step by cooling c), optionally mixed with at least a part of the aqueous composition (B).

In an alternative, at least a part of the mother liquor (II) or (II′), obtained in the crystallisation step (e) or (e′) by evaporation, is processed in the crystallisation by evaporation step c) or c′), optionally mixed with at least a part of the aqueous composition (B) and/or mixed with at least a part of the mother liquor (III) or (III′).

In an alternative embodiment, the aqueous composition comprising lithium sulfate and sodium sulfate supplied at the inlet of the second compartment of said at least one electrodialysis cell of the bipolar membrane electrodialyser (BPED1) of step (a) has undergone a prior treatment to extract divalent cations, in particular calcium ions and magnesium ions. In an alternative, the first and second bipolar membranes of said at least one cell of the BPED1 or BPED2, and the anionic central membrane, or the cationic and anionic membranes of said at least one cell of the BPED2, are polymer membranes.

Advantageously, the anionic membrane, in particular the central anioni membrane, of EDBP1 in step a) is a Neosepta® AHA membrane. However, any anionic membrane may be suitable for use in the EDBP1 electrodialyser.

Advantageously, the bipolar membrane of the EDBP1 in step a) is a Neosepta® BP membrane. However, any bipolar membrane may be suitable for use in the EDBP1 electrodialyser.

In an alternative, the first bipolar membrane or equally the second bipolar membrane of said at least one cell of BPED1 or BPED2, comprises a cationic and therefore cation-exchanging face, and an anionic and therefore anion-exchanging face, which make it possible in an electric field to dissociate water at a voltage greater than or equal to 0.8 volts, and preferably less than or equal to 1.8 volts.

In an alternative, the first bipolar membrane or equally the second bipolar membrane of said at least one cell of BPED1 or BPED2, or equally the anionic central membrane of said at least one cell of BPED1, or equally the anionic and cationic membranes of said at least one cell of BPED2, each has/have a thickness greater than or equal to 30 μm and less than or equal to 600 μm.

In an alternative, the anionic central membrane of said at least one cell of BPED1, or equally the anionic and cationic membranes of said at least one cell of BPED2, is/are each a polymer membrane on which cationic or anionic exchangers are grafted with an exchange capacity greater than or equal to 1 eq/g.

An object of the present invention, according to a second aspect, is a facility for implementing a method for preparing lithium hydroxide, in particular according to any one of the alternative embodiments with reference to the first aspect of the invention, comprising:
a) an electrodialyser (BPED1) comprising, in particular in this order:
   at least one cell comprising, in particular in this order:
      a first bipolar membrane and an anionic membrane, in particular an anionic central membrane, delimiting therebetween, a first compartment having an inlet for the intake of water and an outlet for the discharge of an aqueous composition comprising sulfuric acid, and
   a second bipolar membrane delimiting with an anionic membrane, in particular said anionic central membrane, a second compartment having an inlet for the intake of an aqueous composition (A) comprising lithium sulfate and sodium sulfate and an outlet for the discharge of an aqueous composition (B) comprising sodium sulfate and lithium hydroxide,
b) a crystallisation unit of a salt, in particular a lithium hydroxide salt or a sodium sulfate salt, said salt crystallisation unit comprising an inlet for intake of at least a part of the aqueous composition (B) comprising sodium sulfate and lithium hydroxide, said at least one part of the composition (B) coming from the second compartment of the electrodialyser (BPED1).

In an alternative embodiment:
the salt crystallisation unit c) is a unit for crystallising, in particular by evaporation, lithium hydroxide, comprising an inlet for the intake of at least a part of the aqueous composition (B) comprising sodium sulfate and lithium hydroxide coming from the second compartment of said at least one cell of the electrodialyser (BPED1), and a first outlet for the discharge of solid lithium hydroxide and a second outlet for the discharge of a mother liquor (I) comprising sodium sulfate and lithium hydroxide.

In an alternative embodiment:
the salt crystallisation unit c) is a unit for crystallising, in particular by cooling, sodium sulfate, comprising an inlet for the intake of at least a part of the aqueous composition (B) comprising sodium sulfate and lithium hydroxide coming from the second compartment of said at least one cell of the electrodialyser (BPED1), and a first outlet for the discharge of solid sodium sulfate, in particular a Glauber's salt, and a second outlet for the discharge of a mother liquor (III′) comprising sodium sulfate and lithium hydroxide.

In an alternative, said facility comprises:
a unit d) for dissolving at least a part of the lithium hydroxide salt coming from the crystallisation unit c) in order to form an aqueous composition (C) comprising said dissolved lithium hydroxide salt, and
a crystallisation unit e), in particular by evaporation, comprising an inlet for the intake of at least a part of the aqueous composition (C), and a first outlet for the discharge of lithium hydroxide crystals, and a second outlet for the discharge of a mother liquor (II), in particular said facility further comprises a drying unit f) for said lithium hydroxide crystals, more particularly for obtaining lithium hydroxide monohydrate crystals.

In an alternative, said facility comprises:
a crystallisation unit g), in particular by cooling, comprising an inlet for the intake of at least a part of the mother liquor (I) coming from the crystallisation unit c), and a first outlet for the discharge of a sodium sulfate salt, in particular a Glauber's salt, as well as a second outlet for the discharge of a mother liquor (III) comprising sodium sulfate and lithium hydroxide.

In an alternative, said facility comprises:
a unit h) or h′) for dissolving at least a part of the sodium sulfate salt, in particular of the Glauber's salt, in order to form an aqueous composition (D) or (D′) comprising sodium sulfate, and
a bipolar membrane electrodialyser (BPED2) for processing j) or j′), comprising an inlet for the intake of at least a part of said aqueous composition (D) or (D′) comprising sodium sulfate, and a first outlet for the discharge of sulfuric acid, and a second outlet for the discharge of sodium hydroxide.

In an alternative, said facility comprises:
a unit h) or h′) for preparing an aqueous composition (D) or (D′) from at least a part of the sodium sulfate salt, in particular of the Glauber's salt, in particular a unit h) or h′) for dissolving at least a part of the sodium sulfate salt, in particular of the Glauber's salt, in order to form an aqueous composition (D) or (D′) comprising sodium sulfate, and/or a unit for heating at least a part of the Glauber's salt in order to form an aqueous composition (D) or (D′) in the form of slurry, and
a crystallisation unit i) or i′), in particular by evaporation, comprising an inlet for the intake of at least a part of said aqueous composition (D) or (D′) comprising sodium sulfate, and a first outlet for the discharge of a sodium sulfate salt and a second outlet for the discharge of a mother liquor (IV) or (IV′) comprising sodium sulfate (optionally traces of lithium hydroxide), said facility optionally comprises a unit for the drying step k) or k′) of the sodium sulfate salt coming from the crystallisation unit i) or i′) in order to obtain an anhydrous sodium sulfate salt.

In an alternative embodiment, said facility comprises a unit for conveying at least a part of the mother liquor (III) or (III′) coming from the crystallisation unit g) or c) by cooling, to the crystallisation unit c) or the crystallisation unit c′), said crystallisation unit c) or c′) comprises a first outlet for the discharge of lithium hydroxide and a second outlet for the discharge of the mother liquor (I) or a mother liquor (I′).

In an alternative, said facility comprises:
a unit d′) for dissolving at least a part of the lithium hydroxide salt coming from the crystallisation unit c′) in order to form an aqueous composition (C′) comprising said dissolved lithium hydroxide salt, and
a crystallisation unit e′), in particular by evaporation, comprising an inlet for the intake of at least a part of the aqueous composition (C′), and a first outlet for the discharge of lithium hydroxide crystals, and a second outlet for the discharge of a mother liquor (II′), in particular said facility further comprises a drying unit f′) for said lithium hydroxide crystals.

In an alternate embodiment, said facility comprises a unit for conveying at least a part of the mother liquor (IV) or (IV′) coming from the crystallisation unit i) or i′), to the crystallisation g) or c), in particular by cooling.

The alternative embodiments according to a first aspect can be combined with one another and with the alternative embodiments according to a second aspect.

### BRIEF DESCRIPTION OF THE DRAWINGS

The invention will be better understood upon reading the following description of the various embodiments of the invention, given solely as non-limiting examples and with reference to the attached drawings, wherein:

FIG. 1 schematically shows a first example of a method for preparing lithium hydroxide according to the invention;

FIG. 2 schematically shows a second example of a method for preparing lithium hydroxide according to the invention;

FIG. 3 schematically shows a third example of a method for preparing lithium hydroxide according to the invention;

FIG. 4 schematically shows a fourth example of a method for preparing lithium hydroxide according to the invention;

FIG. 5 schematically shows a cell for a step of anionic bipolar membrane electrodialysis (BPED1) of step a); and

FIG. 6 schematically shows a cell for a step of anionic/cationic bipolar membrane electrodialysis/(BPED2) of step j) or j′);

FIG. 7 shows the change in pH along the y-axis for an aqueous composition (A) in the second compartment of at least one cell of the electrodialyser (BPED1) during electrodialysis step a) (BPED1) as a function of time on the x-axis, for various concentrations of sulfuric acid in the first compartment, corresponding to tests 1 to 3;

FIG. 8 shows the change in conductivity along the y-axis for the aqueous composition (A) in the second compartment of at least one cell of the electrodialyser (BPED1) during electrodialysis step a) (BPED1) as a function of time on the x-axis for various concentrations of sulfuric acid in the first compartment, corresponding to tests 1 to 3;

FIG. 9 shows the change in the production de LiOH (indicated in OH equivalent per litre of the aqueous composition (A), on the y-axis) during electrodialysis step a) (BPED1) as a function of time on the x-axis for various concentrations of sulfuric acid in the first compartment corresponding to tests 2 and 3.

FIG. 10 is a table showing the different initial and final concentrations of Li, Na, OH and SO₄ in the second compartment of EDBP1, the initial or final concentration of sulphuric acid in the first compartment of EDBP1, and the conditions for carrying out tests 1 to 3 on an electrodialyser comprising several cells, such as cell 200 shown in FIG. 5.

### DETAILED DESCRIPTION

The present invention overcomes all or part of the above-mentioned problems in that it has as object, according to a first aspect, a method for preparing lithium hydroxide comprising the steps:
a) subjecting an aqueous composition (A) comprising lithium sulfate and sodium sulfate, to a bipolar membrane electrodialysis (BPED1) in order to convert at least a part, or substantially all, of the lithium sulfate into lithium hydroxide, in particular retaining the sodium sulfate salts;
said step a) of bipolar membrane electrodialysis (BPED1) comprising processing in an electrodialyser comprising at least one electrodialysis cell, said electrodialysis cell comprising:
   a first compartment in which water is supplied, in particular at the inlet of the first compartment, between a first bipolar membrane and an anionic membrane, in particular an anionic central membrane, and
   a second compartment in which said aqueous composition (A) comprising lithium sulfate and sodium sulfate is supplied, in particular at the inlet of the second compartment, between an anionic membrane, in particular said anionic central membrane, and a second bipolar membrane,
b) recovering an aqueous composition (B) comprising lithium hydroxide and sodium sulfate at the outlet of the second compartment of said at least one electrodialysis cell,
c) subjecting at least a part of the aqueous composition (B) comprising lithium hydroxide and sodium sulfate to a crystallisation step of a salt, in particular a lithium hydroxide salt or a sodium sulfate salt.

Advantageously, the bipolar electrodialysis (BPED1) is an anionic, two-compartment bipolar electrodialysis, for extracting excess sulfate ions SO₄²⁻ which can be combined with Li⁺ ions or with Na ions, and producing lithium hydroxide LiOH mixed with sodium sulfate Na₂SO₄.

Said at least one electrodialysis cell of the electrodialyser of step b) (BPED1) preferably substantially consists of (in particular each of the stacked electrodialysis cells of the electrodialyser of step b) (BPED1) substantially consists of) said first and second compartments separated by the anionic central membrane.

Advantageously, the first compartment is delimited between the first bipolar membrane and the anionic central membrane.

Advantageously, the second compartment is delimited between the anionic central membrane and the second bipolar membrane.

Advantageously, said at least one cell is a structural unit repeated several times in order to form a stack of cells in the bipolar electrodialyser (BPED1).

Advantageously, the first bipolar membrane of the first compartment comprises an anionic face oriented towards the anode and a cationic face oriented towards the cathode and towards said anionic central membrane.

Advantageously, the second bipolar membrane of the second compartment comprises an anionic face oriented towards the anode and towards the anionic central membrane, and comprises a cationic face oriented towards the cathode.

A (so-called) bipolar membrane may be, for example, an assembly of two membranes: an anionic membrane and a cationic membrane.

A (so-called) bipolar membrane may be, for example, a cationic membrane comprising anionic exchangers grafted onto one of its two faces or an anionic membrane comprising cationic exchangers grafted onto one of its two faces.

In the present text, “anionic membrane” is understood to mean any membrane allowing the passage of (monovalent and/or multivalent) anions, and therefore not allowing the passage of cations, and “cationic membrane” is understood to mean any membrane allowing the passage of (monovalent and/or multivalent) cations, and therefore not allowing the passage of anions.

The bipolar electrodialysis device (BPED1) comprises a plurality of cells similar to said at least one cell defined above, in particular at least 5 cells, more particularly 25 cells, preferably from approximately 25 cells to approximately 400 cells.

Advantageously, the bipolar electrodialysis device comprises an anode and a cathode disposed on either side of a stack of cells (comprising, for example, from approximately 25 cells to approximately 400 cells).

Advantageously, the anionic central membrane of said at least one cell is an anionic exchange membrane of monovalent and/or multivalent anions.

In an embodiment, the aqueous composition (A) comprising lithium sulfate and sodium sulfate of step a) has a mass content of multivalent cations, in particular divalent cations, less than or equal to 5 ppm (or to 5 mg of cations/kg of composition (A)). Said mass content is calculated with respect to the total mass of the aqueous composition (A) including water.

In the present text, 1 ppm is equal to 1 mg/kg.

In an embodiment, the aqueous composition (A) of step a) results from a method of purification and concentration of lithium salt, in particular lithium sulfate.

In an embodiment, the aqueous composition (A) comprising lithium sulfate, and sodium sulfate of step a), or supplied to the second compartment of said at least one cell of the BPED1, comprises (or substantially consists of) one or more aqueous solutions selected from the list comprising: a solution for extracting lithium dissolved in seawater, brines comprising lithium, for example salars, or geothermal fluid comprising lithium, a solution resulting from a method for recycling a lithium battery, a solution resulting from the treatment of spodumene, or a mixture thereof.

In an embodiment, the water supplied to the first compartment of said at least one electrodialysis cell of the electrodialyser of the BPED1 is demineralised water, or osmosis-purified water, or softened water or results from the condensation of vapours from the crystallisation step by evaporation c), or results from a mixture thereof.

In an embodiment, the temperature of the water supplied to the first compartment of said at least one electrodialysis cell of the electrodialyser of the BPED1 is greater than or equal to 5° C. and less than or equal to 65° C., in particular is substantially equal to the ambient temperature, more particularly is greater than or equal to approximately 15° C. and less than or equal to approximately 50° C. or 40° C.

Preferably, the pH of the water fed to the first compartment of said at least one electrodialysis cell of the EDBP1 electrodialyser, particularly prior to the extraction of sulphate ions, is greater than or equal to 5 and less than or equal to 7.5.

In an embodiment, the temperature of the aqueous composition (A) comprising lithium sulfate and sodium sulfate supplied to the second compartment of said at least one electrodialysis cell of the electrodialyser of BPED1 is greater than or equal to 5° C. and less than or equal to 65° C., in particular is substantially equal to the ambient temperature, more particularly is greater than or equal to approximately 15° C. and less than or equal to 50° C. or 40° C.

Advantageously, the aqueous composition (A) comprises lithium sulphate, sodium sulphate and optionally lithium hydroxide and/or sodium hydroxide (particularly in small quantities). Preferably, the mass fraction of lithium sulphate and sodium sulphate measured on the dry extract by mass of the aqueous composition (A) is greater than or equal to 80%, more preferably greater than or equal to 90%, even more preferably greater than or equal to 95%.

Advantageously, the crystallisation step c) is a separation step allowing the formation of a salt, in particular lithium hydroxide or sodium sulphate, on the one hand, and the formation of a liquor on the other hand, in particular enriched with sodium sulphate or lithium hydroxide (depending on the salt extracted in parallel). Advantageously, the crystallised salt is the majority component in the aqueous composition (B).

In an alternative embodiment, the aqueous composition (A), comprising lithium sulfate and sodium sulfate supplied at the inlet of the second compartment of said at least one electrodialysis cell of the bipolar membrane electrodialyser (BPED1) in step a), has a pH greater than or equal to 4 and less than or equal to 11, preferably less than or equal to 10.5, more preferably less than or equal to 10, even more preferably greater than or equal to 5 or 6, and optionally less than or equal to 8.

In an alternative embodiment, the aqueous composition (B), comprising lithium hydroxide and sodium sulfate at the outlet of the second compartment of said at least one electrodialysis cell of the bipolar membrane electrodialyser (BPED1) in step a), in particular of the electrodialyser of BPED1, has a pH greater than or equal to 9, preferably greater than or equal to 10, more preferably greater than or equal to 11.

Advantageously, the step a) (BPED1) increases the pH of the aqueous composition (A) of step a) because the hydroxyl OH⁻ ions accumulate in the second compartment and form LiOH and the protons H⁺ mostly remain in the first compartment and form H₂SO₄. In one embodiment, the conductivity (mS/cm) of the aqueous composition (A) fed to the inlet of the second compartment of the electrodialyzer (EDBP1) of step a) is greater than or equal to 50 mS/cm.

In an alternative embodiment, the conductivity (mS/cm) of the aqueous composition (B) at the outlet of the second compartment of the electrodialyzer (EDBP1) of step a) is greater than the conductivity of the aqueous composition (A) at the inlet of the second compartment of the said electrodialyzer (EDBP1) of step a), preferably greater than or equal to 100 mS/cm, more preferably greater than or equal to 150 mS/cm.

In an alternative embodiment, the aqueous composition at the outlet of the first compartment of said at least one electrodialysis cell of the bipolar membrane electrodialyser (BPED1) in step a) comprises sulfuric acid, preferably said aqueous composition has a pH less than or equal to 2, more preferably less than or equal to 1.

Preferably, this acid can be recovered or reused in other process lines, notably in the method according to the invention.

In an alternative embodiment, the aqueous composition at the outlet of the first compartment of said at least one electrodialysis cell of the bipolar membrane electrodialyser (BPED1) in step a) comprises sulfuric acid with a mass concentration (g/liter) greater than or equal to 1% and less than or equal to 12%, in particular less than or equal to 10%, optionally greater than or equal to 2% or 4% or 6% or 8%.

In the present text, it is understood by mass concentration of sulphuric acid of x % in a given aqueous composition that this aqueous composition comprises x g of sulphuric acid per 100 g of aqueous composition comprising the said sulphuric acid. In an embodiment, the aqueous composition at the outlet of the first compartment of said at least one electrodialysis cell of the bipolar membrane electrodialyser (BPED1) in step a) comprises sulfuric acid at a mass concentration greater than or equal to 1% and less than or equal to 4%.

In an alternative embodiment, the mass (g) ratio of lithium ions and sodium ions over the total mass (g) of cations in the aqueous composition (A), comprising lithium sulfate and sodium sulfate and supplied at the inlet of the second compartment of said at least one electrodialysis cell of the bipolar membrane electrodialyser (BPED1) in step a), is greater than or equal to 95%.

In one embodiment, the ratio of the mass (g) of lithium ions and sodium ions to the total dry mass (g) of the aqueous composition (A), comprising lithium sulphate and sodium sulphate and fed to the inlet of the second compartment of the said at least one electrodialysis cell of the bipolar membrane electrodialyser (EDBP1) in step a), is greater than or equal to 80%, preferably greater than or equal to 90%, even more preferably greater than or equal to 95%.

In an alternative embodiment, the mass ratio (g/g) between the lithium ions and sodium ions (Li/Na) in the aqueous composition (A), comprising lithium sulfate and sodium sulfate and supplied at the inlet of the second compartment of said at least one electrodialysis cell of the bipolar membrane electrodialyser (BPED1) in step a), is greater than or equal to 0.1 and less than or equal to 9, preferably greater than or equal to 0.4 and less than or equal to 2.3; more preferably greater than or equal to 0.66 and less than or equal to 1.5, preferably greater than or equal to 0.8 and less than or equal to 1.3; more preferably greater than or equal to 0.8 and less than or equal to 1.2; in particular greater than or equal to 0.9 and less than or equal to 1.1; more particularly greater than or equal to 0.95 and less than or equal to 1.05.

In an alternative embodiment, the mass (g) ratio of sulfate ions (SO₄²⁻) and hydroxyl ions (OH⁻), with respect to the total mass (g) of anions in the aqueous composition (A), comprising lithium sulfate and sodium sulfate and supplied at the inlet of the second compartment of said at least one electrodialysis cell of the bipolar membrane electrodialyser (BPED1) in step a), is greater than or equal to 95%.

In one embodiment, the ratio of the mass (g) of sulphate ions (SO₄²⁻) and hydroxyl ions (OH⁻) to the total dry mass (g) of the aqueous composition (A), comprising lithium sulphate and sodium sulphate and fed to the inlet of the second compartment of the said at least one electrodialysis cell of the bipolar membrane electrodialyser (EDBP1) in step a), is greater than or equal to 80%, preferably greater than or equal to 90%, even more preferably greater than or equal to 95%.

The mass fractions of ions are calculated in the present text with respect to the total dry mass of the composition (A) of step a) or the total mass of anions or cations of the composition (A) of step a).

The mass fractions of lithium ions and sodium ions, and of sulfate ions, mentioned above, advantageously allow a BPED1 with two anionic compartments to be carried out.

In an alternative embodiment, the aqueous composition (A) comprising lithium sulfate and sodium sulfate and supplied to the second compartment of said at least one electrodialysis cell of the bipolar membrane electrodialyser (BPED1) in step a) has a mass dry extract greater than or equal to 2% and less than or equal to 20%, in particular less than or equal to 15%, more particularly greater than or equal to 5%.

In an alternative embodiment, the mass ratio between the lithium ions and sodium ions (Li/Na) in the aqueous composition (B), coming from the second compartment of said at least one electrodialysis cell of the bipolar membrane electrodialyser (BPED1) in step a), is similar (specifically to within +/−10%) to the mass ratio between the lithium ions and sodium ions (Li/Na) of the aqueous composition (A) supplied at the inlet of the second compartment of said at least one electrodialysis cell of the bipolar membrane electrodialyser (BPED1) in step a).

Indeed, the lithium and sodium ions are not extracted from the aqueous composition (A) during the electrodialysis of step a) (BPED1).

In an alternative embodiment, the current density (mA/cm²) applied in the bipolar membrane electrodialysis step (EDBP1) in step a), or in the bipolar membrane electrodialysis step (EDBP2) (in particular described below), is greater than or equal to 50 mA/cm² and less than or equal to 100 mA/cm², in particular greater than or equal to 60 mA/cm² and less than or equal to 90 mA/cm².

This is the amount of current (A) applied per surface area (cm²) of ion exchange membrane.

In an alternative embodiment, the quantity of sulfate ions extracted from the composition (A) in step a) is approximately equal to the quantity, in molar equivalent, of lithium ions present in solution in said composition (A), for example 1 mole of extracted sulfate ions corresponds to 2 moles of lithium ions released and potentially complexed by the hydroxyl ions.

In an alternative embodiment, the crystallisation step c) of a salt is a crystallisation step, in particular by evaporation, of a lithium hydroxide salt in order to obtain a lithium hydroxide salt on the one hand, and a mother liquor (I) comprising sodium sulfate and lithium hydroxide on the other hand.

Preferably, in this case, the mass ratio (g/g) Li/Na is high in the composition (A), in particular greater than or equal to 0.8, more particularly greater than or equal to 0.9 or 1.

When the mass concentration of lithium is approximately equivalent to, or greater than, the mass concentration of sodium in the composition (B), it is advantageously possible to start with a crystallisation by evaporation in order to form an impure solid lithium hydroxide salt.

In an embodiment, the crystallisation step by evaporation c) is carried out by heating the aqueous composition (B) to a temperature greater than or equal to 30° C., more particularly less than or equal to 110° C., for example ranging from 50° C. to 70° C., until a solid lithium hydroxide salt is obtained.

Advantageously, the mother liquor (I) obtained in the crystallisation step by evaporation c) has a mass concentration of sodium sulfates greater than or equal to 5% and less than or equal to 30%, preferably greater than or equal to 8% and less than or equal to 25%, more preferably greater than or equal to 10% and less than or equal to 20%, preferably less than or equal to 18%, in particular less than or equal to 16%.

Advantageously, the mother liquor (I) obtained in the crystallisation step by evaporation c) has a mass concentration of lithium hydroxide (LiOH) greater than or equal to 3% and less than or equal to 20%, preferably greater than or equal to 5% and less than or equal to 15%, more preferably greater than or equal to 6% and less than or equal to 10%.

The mass concentrations are calculated by relating the dry mass of sodium sulfates or lithium hydroxide to the total mass of the mother liquor (I) (in particular including water).

In an alternative, said method comprises a step d) of dissolving at least a part of the lithium hydroxide salt obtained in step c) in order to form an aqueous composition (C) comprising said dissolved lithium hydroxide salt, and said method further comprises a crystallisation step e), in particular by evaporation, of at least a part of the aqueous composition (C) in order to obtain lithium hydroxide crystals and, optionally, a mother liquor (II), in particular said lithium hydroxide crystals undergo a drying step f), more particularly in order to obtain lithium hydroxide monohydrate crystals.

Preferably, the mother liquor (II) is rich in lithium hydroxide, and comprises traces of sodium sulfate.

Advantageously, the mother liquor (II) obtained in crystallisation step e) by evaporation has a mass concentration of lithium hydroxide (LiOH) greater than or equal to 6% and less than or equal to 30%, preferably greater than or equal to 8% and less than or equal to 25%, more preferably greater than or equal to 10% and less than or equal to 20%, in particular greater than or equal to 12% and less than or equal to 17%.

Advantageously, the mother liquor (II) obtained in crystallisation step e) by evaporation has a mass concentration of sodium sulfate less than or equal to 10%, preferably less than or equal to 8%, more preferably less than or equal to 6% or 4% or 3%, in particular less than or equal to 2%.

Advantageously, the step d) of dissolving said lithium hydroxide salt in water is carried out such that the mass concentration of lithium hydroxide is less than the solubility of LiOH.

Advantageously, the mass concentration of LiOH in the aqueous composition (C) prepared during dissolution step d) is greater than or equal to 1% and less than or equal to 15%, preferably less than or equal to 12%, more preferably less than or equal to 8%, in particular greater than or equal to 3%.

Advantageously, crystallisation step e), in particular by evaporation, comprises heating the aqueous composition (C), optionally following a drying step f), until lithium hydroxide monohydrate crystals (LiOH, H₂O) are obtained.

The mass concentrations are measured by relating the mass of sodium sulfate or LiOH to the total mass of the mother liquor (including water) or of the aqueous composition (including water) resulting from the dissolution.

The inventors have observed that the mother liquors which surround the lithium salt produced during the first crystallisation by evaporation c) are loaded with sodium sulfate (Na₂SO₄) which can harm the crystalline form of the crystals obtained. Moreover, these mother liquors contribute a non-negligible quantity of Na₂SO₄. The redissolving of the lithium hydroxide salt during the first dissolution d) makes it possible to generate a mother liquor (II) that is much less rich in Na₂SO₄ than the mother liquor (I) obtained during the first crystallisation by evaporation. Advantageously, the crystals obtained in the second crystallisation by evaporation e) are much purer. Performing a second crystallisation by evaporation e) therefore makes it possible to produce LiOH monohydrate crystals of high purity, and a mother liquor (II) depleted in sodium sulfate and therefore enriched in LiOH.

Advantageously, the lithium hydroxide monohydrate obtained has a purity greater than or equal to 95% or 97% or 98% or 99% or 99.5%.

The degree of purity is preferably evaluated with respect to the mass of LiOH monohydrate over the total mass of crystals obtained.

In an alternative embodiment, the crystallisation step by evaporation e) produces a mother liquor (II) comprising sodium sulfate and lithium hydroxide, at least a part of the mother liquor (II), optionally mixed with at least a part of the aqueous composition (B) comprising lithium hydroxide and sodium sulfate, is subjected to the first crystallisation by evaporation c).

In an alternative embodiment, said method comprises a crystallisation step g), in particular by cooling, of at least a part of the mother liquor (I) obtained in the crystallisation step c), in order to obtain a Glauber's salt and a mother liquor (III) comprising sodium sulfate and lithium hydroxide.

Advantageously, the crystallisation step by cooling g) comprises the application of a temperature greater than or equal to −20° C. and less than or equal to 25° C., more particularly a temperature greater than or equal to −10° C. and less than or equal to 15° C.

In the present text, “Glauber's salt” is understood to mean the sodium sulfate of formula (Na₂SO₄; 10H₂O).

Advantageously, the mother liquor (III) is depleted in sodium sulfate.

In an alternative embodiment, the crystallisation step c) of a salt is a crystallisation step, in particular by cooling, of a sodium sulfate salt (Na₂SO₄) in order to obtain a Glauber's salt on the one hand, and a mother liquor (III′) comprising lithium hydroxide and sodium sulfate on the other hand.

Preferably, in this case, the mass ratio Li/Na is low in the composition (A), in particular less than or equal to 0.8.

When the mass concentration of lithium is too low in the composition (A), it is advantageously possible to start with a crystallisation by cooling in order to form a sodium sulfate salt.

In an alternative embodiment, said method comprises:
a step h) or h′) of dissolving all or part of the Glauber's salt, in particular coming from the crystallisation step by cooling g) or c), so as to form an aqueous composition (D) or (D′) comprising sodium sulfate, and
processing j) or j′) at least a part of said aqueous composition (D) or (D′) comprising sodium sulfate by a bipolar membrane electrodialysis (BPED2), in order to extract sulfate ions, on the one hand, and to form sulfuric acid and extract sodium ions on the other hand and to form sodium hydroxide.

Advantageously, the bipolar membrane electrodialysis (BPED2) is carried out in an electrodialyser comprising at least one electrodialysis cell, said at least one electrodialysis cell comprises (in particular substantially consists of) three compartments, and comprises first and second bipolar membranes, a first anionic membrane and a first cationic membrane.

Advantageously, said at least one electrodialysis cell comprises (in particular substantially consists of):
a first compartment supplied with water circulating between a first bipolar membrane and an anionic membrane, in particular the first bipolar membrane has an anionic face oriented towards the anode of the electrodialyser, and a cationic face oriented towards the anionic membrane;
a second compartment supplied with the aqueous composition (D) or (D′) comprising sodium sulfate circulating between the anionic membrane and a cationic membrane; and
a third compartment supplied with water circulating between the cationic membrane and a second bipolar membrane; in particular the second bipolar membrane has an anionic face oriented towards the cationic membrane, and a cationic face oriented towards the cathode of the electrodialyser.

Advantageously, the second compartment is disposed between the first and third compartments.

Advantageously, the aqueous composition at the outlet of the first compartment comprises sulfuric acid, and the aqueous composition at the outlet of the third compartment comprises sodium hydroxide (NaOH).

Advantageously, the aqueous composition (D) or (D′) comprising sodium sulfate at the inlet of the second compartment of said at least one cell of the electrodialyser (BPED2) is depleted in sodium sulfate.

In an alternative, said method comprises:
a step of preparing an aqueous composition (D) or (D′) from all or part of the Glauber's salt, in particular a step of dissolution h) or h′) of all or part of the Glauber's salt so as to form an aqueous composition (D) or (D′) comprising sodium sulfate or a step of heating the Glauber's salt so as to form an aqueous composition (D) or (D′) comprising sodium sulfate, in particular in the form of a slurry of said Glauber's salt, and
a crystallisation step i) or i′), in particular by evaporation, of at least a part of said aqueous composition (D) or (D′) comprising sodium sulfate, in order to obtain an anhydrous sodium sulfate salt and a mother liquor IV) or IV′) comprising sodium sulfate, and optionally traces of lithium hydroxide, and said crystallisation step i) or i′) is optionally followed by a drying step k) or k′) of the sodium sulfate salt obtained in the crystallisation step i) or i′).

Advantageously, the crystallisation step by evaporation i) or i′) comprises heating the aqueous composition (D) or (D′) comprising sodium sulfate to a temperature greater than or equal to 50° C. and less than or equal to 110° C., preferably to a temperature greater than or equal to 60° C. and less than or equal to 90° C., for example of order 80° C.+/−5° C.

In an alternative embodiment, the crystallisation step by cooling g) or c) is carried out so as to produce a mother liquor (III) or (III′) comprising:
sodium sulfate, for which, in particular, the mass concentration (in particular calculated with respect to the total mass of the liqueur including water) is greater than or equal to 5%, and less than or equal to 30%, preferably greater than or equal to 8% or 10% and less than or equal to 25% or 20%, more preferably less than or equal to 16%; and/or
lithium hydroxide, for which, in particular, the mass concentration (in particular calculated with respect to the total mass of the liqueur including water) is greater than or equal to 3%, and less than or equal to 20%, preferably greater than or equal to 4% or 6% and less than or equal to 20% or 15%, more preferably less than or equal to 10%.

In an alternative embodiment, the aqueous composition (D) or (D′) comprising sodium sulfate obtained by dissolving at least a part of the Glauber's salt obtained in the crystallisation step c) or g), has a mass concentration of sodium sulfate (calculated, in particular, with respect to its total mass including water) greater than or equal to 10% and less than or equal to 40%, preferably greater than or equal to 20% and less than or equal to 35%, more preferably greater than or equal to 24% and less than or equal to 30%, in particular at a temperature ranging from 15° C. to 40° C., more particularly at a temperature ranging from 25° C. to 40° C., for example of order 35° C.+/−2° C.

Advantageously, the mass concentration of sodium sulfate in the composition (D) or (D′) is determined as a function of the temperature of the aqueous composition and in order to be less than the threshold solubility of sodium sulfate.

The aqueous composition (D) or (D′), prepared in this way by dissolving at least a part of the Glauber's salt, can undergo a bipolar membrane electrodialysis j) or j′) or a crystallisation by evaporation i) or i′) as described above.

In an alternative embodiment, the crystallisation step by evaporation i) or i′) is carried out so as to produce a mother liquor (IV) or (IV′) comprising:
sodium sulfate, for which, in particular, the mass concentration (in particular calculated with respect to the total mass of the liqueur including water) is greater than or equal to 15%, and less than or equal to 44%, preferably greater than or equal to 20% or 25% and less than or equal to 30%, for example of order 26%+/−2%; and
lithium hydroxide, for which, in particular, the mass concentration (in particular calculated with respect to the total mass of the liqueur including water) is less than or equal to 10% and preferably less than or equal to 5%, more preferably less than or equal to 3% or 2%.

In an alternative, at least a part of the mother liquor (III) or (III′) obtained in crystallisation step g) or c), in particular by cooling, of sodium sulfate Na₂SO₄, undergoes a crystallisation step, in particular by evaporation, of lithium hydroxide (LiOH), in particular it involves the crystallisation step c) (in particular as described above) or a crystallisation step c′), more particularly in order to obtain an (in particular impure) lithium hydroxide salt on the one hand and the mother liquor (I) (in particular as described above) or a mother liquor (I′) comprising sodium sulfate and lithium hydroxide on the other hand.

Preferably, in this case, the mass ratio Li/Na in the mother liquor III or III′ is high, in particular greater than or equal to 0.8, more particularly greater than or equal to 0.9 or 1.

In an embodiment, the crystallisation step by evaporation c′) is carried out by heating the mother liquor (III′) to a temperature greater than or equal to 30° C., more particularly less than or equal to 110° C., for example ranging from 50° C. to 70° C., until a solid lithium hydroxide salt is obtained.

Advantageously, the mother liquor (I′) obtained in the crystallisation step by evaporation c′) has a mass concentration of sodium sulfates greater than or equal to 5% and less than or equal to 30%, preferably greater than or equal to 8% and less than or equal to 25%, more preferably greater than or equal to 10% and less than or equal to 20%, preferably less than or equal to 18%, in particular less than or equal to 16%.

Advantageously, the mother liquor (I′) obtained in the crystallisation step by evaporation c′) has a mass concentration of lithium hydroxide (LiOH) greater than or equal to 3% and less than or equal to 20%, preferably greater than or equal to 5% and less than or equal to 15%, more preferably greater than or equal to 6% and less than or equal to 10%.

The mass concentrations are calculated by relating the dry mass of sodium sulfates or lithium hydroxide to the total mass of the mother liquor (I) (in particular including water).

In an alternative, said method comprises a step d′) of dissolving at least a part of the lithium hydroxide salt obtained in crystallisation step c′) in order to form an aqueous composition (C′) comprising said dissolved lithium hydroxide salt, and said method comprises a crystallisation step e′), in particular by evaporation, of at least a part of the aqueous composition (C′) in order to obtain lithium hydroxide crystals and, optionally, a mother liquor (II′), in particular said lithium hydroxide crystals undergo a drying step f′), more particularly in order to obtain lithium hydroxide monohydrate crystals.

Preferably, the mother liquor (II′) is rich in lithium hydroxide, and comprises traces of sodium sulfate.

Advantageously, the mother liquor (II′) obtained in crystallisation step e′) by evaporation has a mass concentration of lithium hydroxide (LiOH) greater than or equal to 6% and less than or equal to 30%, preferably greater than or equal to 8% and less than or equal to 25%, more preferably greater than or equal to 10% and less than or equal to 20%, in particular greater than or equal to 12% and less than or equal to 17%.

Advantageously, the mother liquor (II′) obtained in crystallisation step e′) by evaporation has a mass concentration of sodium sulfate less than or equal to 10%, preferably less than or equal to 8%, more preferably less than or equal to 6% or 4% or 3%, in particular less than or equal to 2%.

Advantageously, the step d′) of dissolving said lithium hydroxide salt in water is carried out such that the mass concentration of lithium hydroxide is less than the solubility of LiOH.

Advantageously, the mass concentration of LiOH in the aqueous composition (C′) prepared during dissolution step d′) is greater than or equal to 1% and less than or equal to 15%, preferably less than or equal to 12%, more preferably less than or equal to 8%, in particular greater than or equal to 3%.

Advantageously, crystallisation step e′), in particular by evaporation, comprises heating the aqueous composition (C′), optionally following a drying step f′), until lithium hydroxide monohydrate crystals (LiOH, H₂O) are obtained.

The mass concentrations are measured by relating the mass of sodium sulfate or LiOH to the total mass of the mother liquor (including water) or of the aqueous composition (including water) resulting from the dissolution.

The inventors have observed that the mother liquors which surround the lithium salt produced during the crystallisation by evaporation c′) are loaded with sodium sulfate (Na₂SO₄) which can harm the crystalline form of the crystals obtained. Moreover, these mother liquors contribute a non-negligible quantity of Na₂SO₄. The redissolving of the lithium hydroxide salt during the dissolution d′) makes it possible to generate a mother liquor (II′) that is much less rich in Na₂SO₄ than the mother liquor (I′) obtained during the crystallisation by evaporation c′). Advantageously, the crystals obtained in the crystallisation by evaporation e′) are much purer. Performing a second crystallisation by evaporation e′) therefore makes it possible to produce LiOH monohydrate crystals of high purity, and a mother liquor (II′) depleted in sodium sulfate and therefore enriched in LiOH.

Advantageously, the lithium hydroxide monohydrate obtained has a purity greater than or equal to 95% or 97% or 98% or 99% or 99.5%.

The degree of purity is preferably evaluated with respect to the mass of LiOH monohydrate over the total mass of crystals obtained.

In an alternative, at least a part of the mother liquor (IV) or (IV′) obtained in the crystallisation step i) or i′), in particular by evaporation, of at least a part of the aqueous composition (D) or (D′) coming at least in part from the dissolution of Glauber's salt, undergoes a crystallisation step g) or c), in particular by cooling, optionally mixed with at least a part of the aqueous composition (B).

In an alternative embodiment, at least a part of the Glauber's salt obtained in the crystallisation step by cooling c) or g) is heated, in particular to a temperature greater than or equal to 25° C., more particularly greater than or equal to 31° C.

Advantageously, a slurry of anhydrous sodium sulfate is obtained in a solution saturated with sodium sulfate.

Advantageously, during heating, the Glauber's salt releases its combined water, enabling the formation of said slurry. This step is referred to as the ‘Melt’.

Advantageously, said method comprises a crystallisation step by evaporation of said slurry in order to crystallise all of the sodium sulfate.

Nevertheless, this pathway is more delicate to implement in order to obtain beautiful sodium sulfate crystals.

In an alternative, at least a part of the mother liquor (I′), obtained in the crystallisation step by evaporation c′), is processed in the crystallisation step by cooling c), optionally mixed with at least a part of the aqueous composition (B).

In an alternative, at least a part of the mother liquor (II) or (II′), obtained in the crystallisation step (e) or (e′) by evaporation, is processed in the crystallisation by evaporation step c) or c′), optionally mixed with at least a part of the aqueous composition (B) and/or mixed with at least a part of the mother liquor (III) or (III′).

In an alternative embodiment, the aqueous composition comprising lithium sulfate and sodium sulfate supplied at the inlet of the second compartment of said at least one electrodialysis cell of the bipolar membrane electrodialyser (BPED1) of step (a) has undergone a prior treatment to extract divalent cations, in particular calcium ions and magnesium ions. In an alternative, the first and second bipolar membranes of said at least one cell of the BPED1 or BPED2, and the anionic central membrane, or the cationic and anionic membranes of said at least one cell of the BPED2, are polymer membranes.

Advantageously, the anionic membrane, in particular the central anioni membrane, of EDBP1 in step a) is a Neosepta® AHA membrane. However, any anionic membrane may be suitable for use in the EDBP1 electrodialyser.

Advantageously, the bipolar membrane of the EDBP1 in step a) is a Neosepta® BP membrane. However, any bipolar membrane may be suitable for use in the EDBP1 electrodialyser.

In an alternative, the first bipolar membrane or equally the second bipolar membrane of said at least one cell of BPED1 or BPED2, comprises a cationic and therefore cation-exchanging face, and an anionic and therefore anion-exchanging face, which make it possible in an electric field to dissociate water at a voltage greater than or equal to 0.8 volts, and preferably less than or equal to 1.8 volts.

In an alternative, the first bipolar membrane or equally the second bipolar membrane of said at least one cell of BPED1 or BPED2, or equally the anionic central membrane of said at least one cell of BPED1, or equally the anionic and cationic membranes of said at least one cell of BPED2, each has/have a thickness greater than or equal to 30 μm and less than or equal to 600 μm.

In an alternative, the anionic central membrane of said at least one cell of BPED1, or equally the anionic and cationic membranes of said at least one cell of BPED2, is/are each a polymer membrane on which cationic or anionic exchangers are grafted with an exchange capacity greater than or equal to 1 eq/g.

An object of the present invention, according to a second aspect, is a facility for implementing a method for preparing lithium hydroxide, in particular according to any one of the alternative embodiments with reference to the first aspect of the invention, comprising:
a) an electrodialyser (BPED1) comprising, in particular in this order:
   at least one cell comprising, in particular in this order:
a first bipolar membrane and an anionic membrane, in particular an anionic central membrane, delimiting therebetween, a first compartment having an inlet for the intake of water and an outlet for the discharge of an aqueous composition comprising sulfuric acid, and
   a second bipolar membrane delimiting with an anionic membrane, in particular said anionic central membrane, a second compartment having an inlet for the intake of an aqueous composition (A) comprising lithium sulfate and sodium sulfate and an outlet for the discharge of an aqueous composition (B) comprising sodium sulfate and lithium hydroxide,
b) a crystallisation unit of a salt, in particular a lithium hydroxide salt or a sodium sulfate salt, said salt crystallisation unit comprising an inlet for intake of at least a part of the aqueous composition (B) comprising sodium sulfate and lithium hydroxide, said at least one part of the composition (B) coming from the second compartment of the electrodialyser (BPED1).

In an alternative embodiment:
the salt crystallisation unit c) is a unit for crystallising, in particular by evaporation, lithium hydroxide, comprising an inlet for the intake of at least a part of the aqueous composition (B) comprising sodium sulfate and lithium hydroxide coming from the second compartment of said at least one cell of the electrodialyser (BPED1), and a first outlet for the discharge of solid lithium hydroxide and a second outlet for the discharge of a mother liquor (I) comprising sodium sulfate and lithium hydroxide.

In an alternative embodiment:
the salt crystallisation unit c) is a unit for crystallising, in particular by cooling, sodium sulfate, comprising an inlet for the intake of at least a part of the aqueous composition (B) comprising sodium sulfate and lithium hydroxide coming from the second compartment of said at least one cell of the electrodialyser (BPED1), and a first outlet for the discharge of solid sodium sulfate, in particular a Glauber's salt, and a second outlet for the discharge of a mother liquor (III′) comprising sodium sulfate and lithium hydroxide.

In an alternative, said facility comprises:
a unit d) for dissolving at least a part of the lithium hydroxide salt coming from the crystallisation unit c) in order to form an aqueous composition (C) comprising said dissolved lithium hydroxide salt, and
a crystallisation unit e), in particular by evaporation, comprising an inlet for the intake of at least a part of the aqueous composition (C), and a first outlet for the discharge of lithium hydroxide crystals, and a second outlet for the discharge of a mother liquor (II), in particular said facility further comprises a drying unit f) for said lithium hydroxide crystals, more particularly for obtaining lithium hydroxide monohydrate crystals.

In an alternative, said facility comprises:
a crystallisation unit g), in particular by cooling, comprising an inlet for the intake of at least a part of the mother liquor (I) coming from the crystallisation unit c), and a first outlet for the discharge of a sodium sulfate salt, in particular a Glauber's salt, as well as a second outlet for the discharge of a mother liquor (III) comprising sodium sulfate and lithium hydroxide.

In an alternative, said facility comprises:
a unit h) or h′) for dissolving at least a part of the sodium sulfate salt, in particular of the Glauber's salt, in order to form an aqueous composition (D) or (D′) comprising sodium sulfate, and
a bipolar membrane electrodialyser (BPED2) for processing j) or j′), comprising an inlet for the intake of at least a part of said aqueous composition (D) or (D′) comprising sodium sulfate, and a first outlet for the discharge of sulfuric acid, and a second outlet for the discharge of sodium hydroxide.

In an alternative, said facility comprises:
a unit h) or h′) for preparing an aqueous composition (D) or (D′) from at least a part of the sodium sulfate salt, in particular of the Glauber's salt,
in particular a unit h) or h′) for dissolving at least a part of the sodium sulfate salt, in particular of the Glauber's salt, in order to form an aqueous composition (D) or (D′) comprising sodium sulfate, and/or a unit for heating at least a part of the Glauber's salt in order to form an aqueous composition (D) or (D′) in the form of slurry, and
a crystallisation unit i) or i′), in particular by evaporation, comprising an inlet for the intake of at least a part of said aqueous composition (D) or (D′) comprising sodium sulfate, and a first outlet for the discharge of a sodium sulfate salt and a second outlet for the discharge of a mother liquor (IV) or (IV′) comprising sodium sulfate (optionally traces of lithium hydroxide), said facility optionally comprises a unit for the drying step k) or k′) of the sodium sulfate salt coming from the crystallisation unit i) or i′) in order to obtain an anhydrous sodium sulfate salt.

In an alternative embodiment, said facility comprises a unit for conveying at least a part of the mother liquor (III) or (III′) coming from the crystallisation unit g) or c) by cooling, to the crystallisation unit c) or the crystallisation unit c′), said crystallisation unit c) or c′) comprises a first outlet for the discharge of lithium hydroxide and a second outlet for the discharge of the mother liquor (I) or a mother liquor (I′).

In an alternative, said facility comprises:
a unit d′) for dissolving at least a part of the lithium hydroxide salt coming from the crystallisation unit c′) in order to form an aqueous composition (C′) comprising said dissolved lithium hydroxide salt, and
a crystallisation unit e′), in particular by evaporation, comprising an inlet for the intake of at least a part of the aqueous composition (C′), and a first outlet for the discharge of lithium hydroxide crystals, and a second outlet for the discharge of a mother liquor (II′), in particular said facility further comprises a drying unit f′) for said lithium hydroxide crystals.

In an alternate embodiment, said facility comprises a unit for conveying at least a part of the mother liquor (IV) or (IV′) coming from the crystallisation unit i) or i′), to the crystallisation g) or c), in particular by cooling.

The alternative embodiments according to a first aspect can be combined with one another and with the alternative embodiments according to a second aspect.

### Definitions

In the present text, “dry extract by mass” is understood to mean the dry mass of a given aqueous composition, obtained after evaporation of the water until a stable total dry mass is obtained based on the total mass of the aqueous composition, in particular at atmospheric pressure.

The methods which can be used to quantify the cations and anions of an aqueous composition (sodium, lithium, sulfates, etc.) can be selected from the following methods: molecular absorption spectrometry, titrimetric/complexometric method, electrochemical method, atomic spectrometry, capillary electrophoresis, ionic chromatography/conductimetric detection, nuclear magnetic resonance for ³¹P, enzymatic method/UV detection, preferably ion chromatography.

The conductivity (μsiemens/cm) or electrolytic conductivity and the pH, are preferably measured using a conductivity and pH measurement probe, for example of the pH/Conductivity type: WTW3110.

In this text, the mass concentrations of sodium sulphates or lithium hydroxide are calculated by relating the dry mass of sodium sulphates or lithium hydroxide to the total mass of the mother liquor (I) or (I′) or (II) or (II′) or (III) or (III′) or (IV) or (IV′) (in particular including the water of the liquor), or in relation to the total mass of the diluted aqueous composition (C) or (C′) or (D) or (D′) (in particular including the water of the diluted aqueous composition), in particular the mass concentration corresponds to the ratio of the mass in grams of sodium sulphates or lithium hydroxide per 100 g of the diluted composition including water or 100 g of the liquor including water.

In the present text “at least a part of a given product (aqueous composition, mother liquor, salt, etc.)” is understood to mean that only a part of this product or substantially all of this product is used.

### EXAMPLES

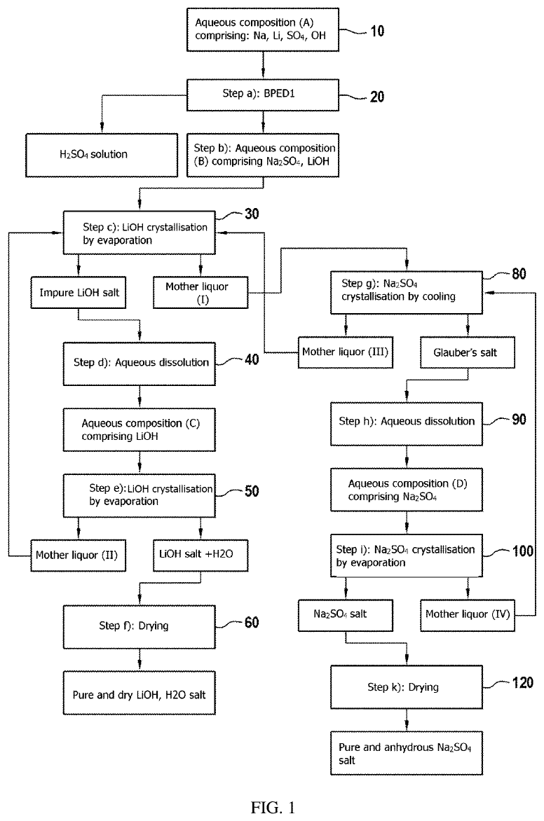

The first example method for preparing lithium hydroxide shown in FIG. 1 comprises a first step 10 of providing an aqueous composition (A) or on the total dry mass of the composition (A), comprising sodium sulfate and lithium sulfate, in particular having undergone a prior step of extraction of multivalent cations, in particular magnesium and calcium ions. In this example, the dry extract mass of the composition (A) is between 8% and 16%, the mass ratio of sodium ions and lithium over the total mass of cations in said composition (A), or on the total dry mass of the composition (A), is greater than or equal to 95%, the mass ratio of sulfate and hydroxyl ions over the total mass of anions in said composition (A) is greater than or equal to 95%. The initial pH of the aqueous composition (A) is preferably between 5 and 8. The mass ratio of lithium sulfates/sodium sulfates is preferably greater than 1, in this example exactly of order 1.5.

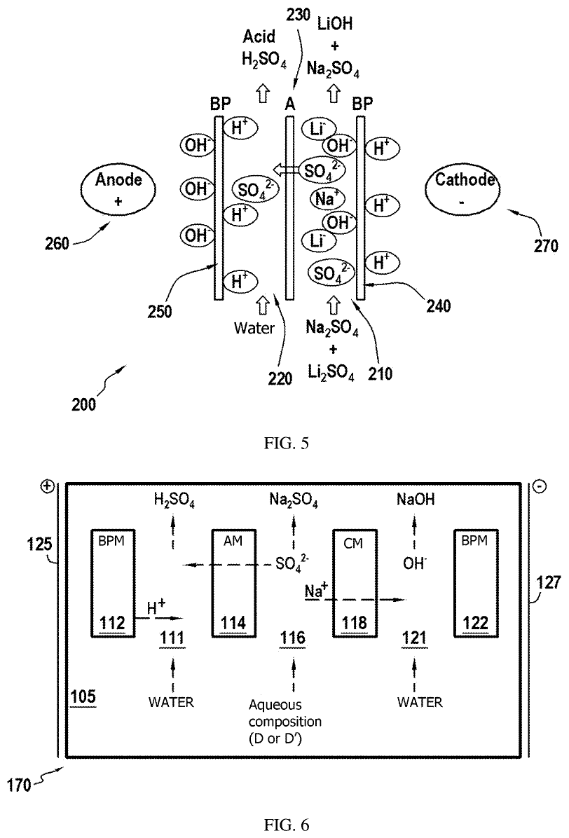

This aqueous composition (A) undergoes a step 20 of bipolar membrane electrodialysis a) (BPED1) by means of an electrodialyser comprising at least one electrodialysis cell, such as, for example, at least the cell 200 shown in schematic manner in FIG. 5.

### Operation of the Cell 200 Shown in FIG. 5

Advantageously, during step a) 20, the aqueous composition (A) is supplied to the second compartment 210 of said at least one cell 200. Demineralised, in particular reverse-osmosis, water is supplied to the first compartment 220 of said at least one cell 200. The first compartment 220 is delimited between an anionic central membrane 230 and a first bipolar membrane 250. The second compartment 210 is delimited between the anionic central membrane 230 and a second bipolar membrane 240. A stack of several cells, such as the cell 200, is disposed between an anode 260 and a cathode 270. Advantageously, the first bipolar membrane 250 has a cationic face oriented towards the anionic central membrane 230 and an anionic face oriented towards the anode 260.

Advantageously, the second bipolar membrane 240 has a cationic face oriented towards the cathode 270, and an anionic face oriented towards the anionic central membrane 230.

When a voltage is applied to said at least one cell 200, hydroxyl ions OH⁻ and protons H⁺ are produced at the first and second bipolar membranes 250 and 270 so that the first compartment 220 is supplied with protons (H⁺) and the second compartment 210 is supplied with hydroxyl ions (OH⁻). The sulfate ions pass through the anionic central membrane 230, and migrate from the second compartment 210 to the first compartment 220, thus reducing the concentration of sulfates in the second compartment. The migration of sulfate ions to the first compartment 220, combined with the production of hydroxyl ions in the second compartment 210, makes it possible to produce lithium hydroxide in the second compartment 210 mixed with sodium sulfate. The pH of the aqueous composition (B) at the outlet of the second compartment 210 is therefore increased and is, in particular, greater than or equal to 8, more particularly greater than or equal to 10. The pH of the water at the outlet of the first compartment is lowered and is, in particular, less than or equal to 2 or 1 due to the formation of sulfuric acid.

The first method example then comprises a first crystallisation step by evaporation c) 30 of a part of the lithium hydroxide of the aqueous composition (B) coming from the second compartment 210 of the cell 200. During the crystallisation step by evaporation c) 30, the aqueous composition (B) is heated then concentrated by evaporation, preferably at a temperature ranging from approximately 30° C. to approximately 110° C., for example at a temperature of approximately 60° C., until (in particular, impure) solid lithium hydroxide is formed on the one hand, and a mother liquor I on the other hand. The mother liquor I comprises lithium hydroxide (the mass concentration of which is preferably between 6% and 10%) and sodium sulfate (the mass concentration of which is preferably between 10% and 16%). The mass concentrations are calculated with respect to the total mass of the mother liquor I.

The solid LiOH salt obtained after the crystallisation step by evaporation c) 30 is impure. Advantageously, in order to purify it, at least a part of this LiOH salt is dissolved in demineralised water in an aqueous dissolution step d) in order to form an aqueous composition (C) comprising a LiOH salt. In particular, the quantity of water added is a function of the solubility threshold of LiOH, the quantity of LiOH must remain less than its solubility threshold in order to avoid a precipitation/agglomeration of the LiOH in solution. The aqueous composition (C) thus preferably comprises approximately 6% by mass of LiOH at approximately 35° C. This aqueous composition (C) then undergoes a second crystallisation step by evaporation e) 50, in particular the aqueous composition (C) is heated to between 30° C. and 110° C., in particular to approximately 60° C. This step e) 50 enables the formation of a solid LiOH monohydrate salt and a mother liquor II comprising lithium hydroxide (the mass concentration of which is preferably between 13% and 16%) and sodium sulfate (the mass concentration of which is preferably less than 2%). Step 50 can be followed by a drying step f) 60, for example at a heating temperature of order 50° C., until a dry purified lithium hydroxide monohydrate salt (LiOH, H₂O) is produced.

The mother liquor II resulting from step 50, being weakly loaded with sulfates and rich in LiOH, can be recycled by being supplied to the first crystallisation step c) by evaporation 30, optionally mixed with at least a part of the aqueous composition (B). The second crystallisation step by evaporation e) 50 makes it possible to obtain, in particular after drying f) 60, high-purity LiOH monohydrate crystals that are suitable for the grades required for the manufacture of batteries.

The mother liquor I coming from the first crystallisation by evaporation c) 30 can advantageously be recycled by subjecting at least a part thereof to a first crystallisation by cooling g) 80, in particular by applying a cooling temperature between −10° C. and +15° C., in particular of order 0° C. Indeed, the mother liquor I at the outlet of step c) 60, having been heated, is at a temperature of order approximately 60° C.-70° C. This calorific energy is thus used in step g) 80 to produce a mother liquor III comprising lithium hydroxide (the mass concentration of which is preferably between 6% and 10%) and sodium sulfate (the mass concentration of which is preferably between 10% and 16%) and to crystallise the sodium sulfate. This mother liquor III being rich in lithium hydroxide can advantageously be recycled during the first crystallisation by evaporation c) 30, optionally by being mixed, at least in part, with the aqueous composition B. The step g) 80 also enables the production of a sodium sulfate salt, in particular a Glauber's salt (Na₂SO₄, 10H₂O). At least part of the Glauber's salt obtained in step g) 80 is dissolved in water, in particular distilled water, during a dissolution step h) 90, preferably at a mass concentration ranging from 20% to 30%, for example of order 27%-28% at 35° C. Preferably, the mass concentration of sodium sulfate in the produced aqueous composition (D) is determined so as to remain below the solubility threshold thereof. The aqueous composition (D) comprising the dissolved Glauber's salt can then advantageously undergo a crystallisation step by evaporation i) 100 during which the composition (D) is heated, in particular to a temperature ranging from approximately 50° C. to approximately 110° C., for example to approximately 80° C. This step i) 100 can be followed by a drying step k) 120, in particular at a temperature of 80-90° C. The salt obtained is preferably an anhydrous sodium sulfate salt. This crystallisation step by evaporation i) 100 enables the formation of a mother liquor IV comprising lithium hydroxide (the mass concentration of which is preferably less than or equal to 2%) and sodium sulfate (the mass concentration of which is preferably between 25% and 35%, for example of order 30%). The mother liquor IV can be recycled in the crystallisation step by cooling g) 80, optionally mixed with the mother liquor I.

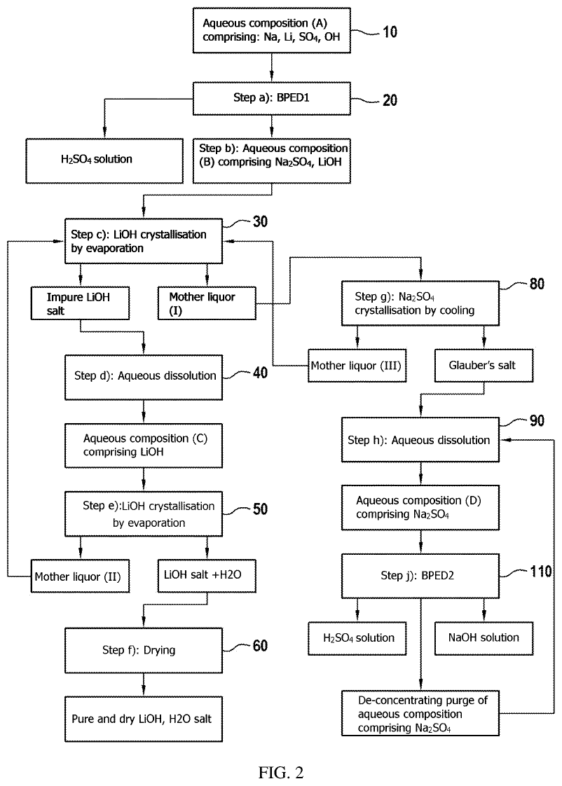

The second method example shown in FIG. 2 is similar to the first method example, and differs therefrom in the steps applied to the aqueous composition (D). The steps of the first method example included in the second method example have the same reference signs.

In the second method example, the aqueous composition (D) undergoes a bipolar membrane electrodialysis (BPED2) step j) 110 and not a crystallisation step i).

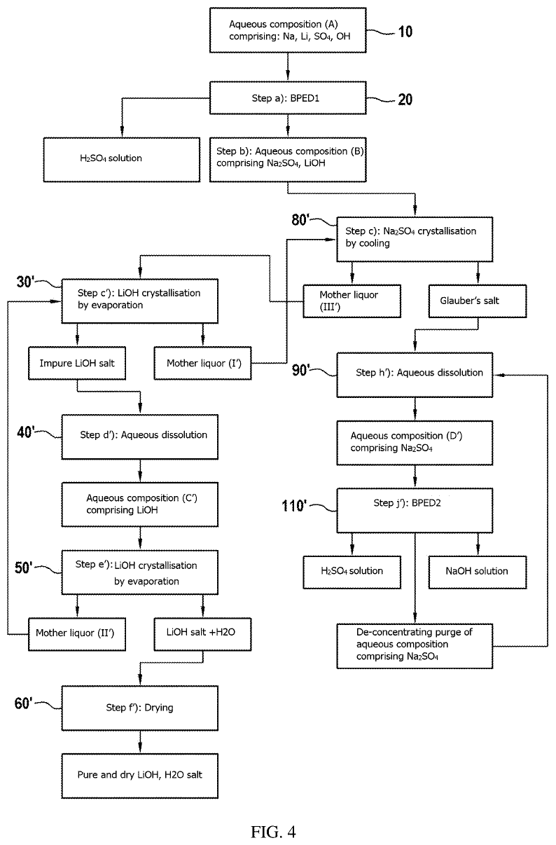

The bipolar membrane electrodialyser of step j) 110 (or step j′) 110′ is the fourth method example illustrated in FIG. 4 and described below) comprises a stack of cells, such as cell 170 schematically shown in FIG. 6.

### Operation of the Cell 170 Shown in FIG. 6

In practice, the composition (D) (or D′ in the case of the fourth method example illustrated in FIG. 4 and described below) is supplied in the central compartment 116 of the cell 170 and circulates between an anionic membrane (AM) 114 and a cationic membrane (CM) 118. Water, in particular distilled water (or softened water), is supplied in parallel in a first compartment 111 of the electrodialysis cell 170 and in a third compartment 121 of the electrodialysis cell 170. The water circulates in the first compartment 111 between a bipolar membrane 112 and the anionic membrane 114. In the third compartment 121, the water circulates between the cationic membrane 118 and the bipolar membrane 122. The bipolar membrane 112 comprises an anionic face oriented towards the anode 125, and a cationic face oriented towards the anionic membrane 114.

The bipolar membrane 122 comprises an anionic face oriented towards the cationic membrane 118, and a cationic face oriented towards the cathode 127.

Due to the bipolar membranes 112 and 122, protons migrate into the first compartment 111, and hydroxyl ions migrate into the third compartment 121.

Advantageously, the sulfate ions of the composition (D) (or D′ in the case of the fourth method example) in the central second compartment 116 migrate through the anionic membrane 114 and accumulate in the first compartment 111 in order to produce sulfuric acid.

Advantageously, the sodium ions of the composition (D) (or D′ in the case of the fourth method example) in the central second compartment 116 migrate through the cationic membrane 118, and accumulate in the third compartment 121 in order to form sodium hydroxide.

The de-concentrating purge of the electrodialyser in step j) 110 (or in step j′) 110′ in the case of the fourth method example below) comprising a sodium sulfate salt, can be supplied in step h) (or in step h′ in the case of the fourth method example below) in order to be diluted and hence to produce an aqueous composition (D) (or D′ in the case of the fourth method example).

Step j) 110 (or the step j′) 110′) advantageously makes it possible to form a base and an acid from the sodium sulfate salt that is recycled in the method for preparing lithium hydroxide. The base and the acid formed can be used in methods upstream of the method for preparing lithium hydroxide in the extraction, purification and concentration steps for preparing a lithium-rich composition. Sulfuric acid can, in particular, be used as an eluent applied to certain DLE (Direct Lithium Extraction).

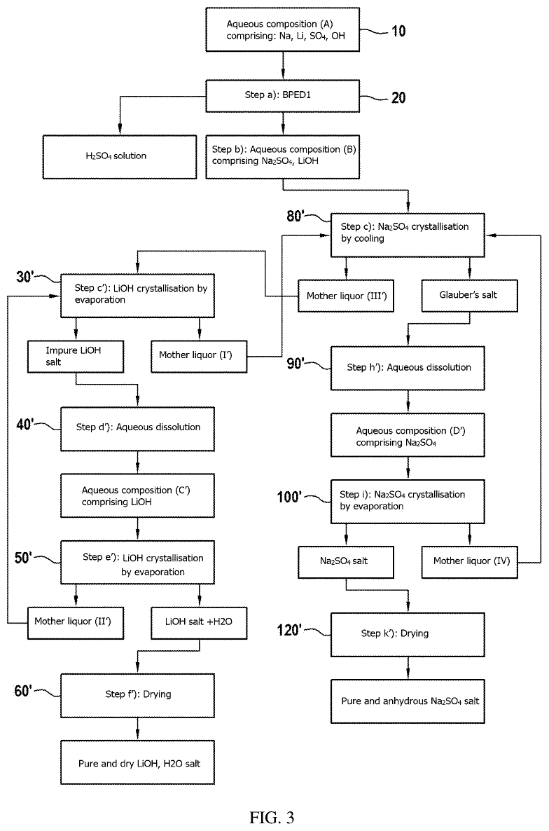

The third method example, shown in FIG. 3, comprises, in a similar manner to the first and second method example, a bipolar membrane electrodialysis step a) 20 (BPED1) during which the aqueous composition (A) is processed in order to produce an aqueous composition (B) in step b), in particular as described above, more particularly with reference to the operation of the cell 200 of FIG. 5.

The third method example is preferably implemented when the mass concentration of sodium ions is greater than the mass concentration of lithium ions so that after step b), a crystallisation step c) 80′ is carried out by cooling the sodium sulfate salt in order to produce a mother liquor III′ in which the mass concentration of lithium ions is increased and a sodium sulfate salt, in particular a Glauber's salt. Preferably, the crystallisation step c) 80′ by cooling is carried out by applying a cooling temperature between −10° C. and +15° C.

The mother liquor III′ can then undergo a crystallisation step by evaporation c′) 30′ of a part of the lithium hydroxide that it comprises. During the crystallisation step by evaporation c′) 30′, the mother liqueur III′ is heated then concentrated by evaporation, preferably at a temperature ranging from approximately 30° C. to approximately 110° C., for example at a temperature of approximately 60° C., until (in particular, impure) solid lithium hydroxide is formed on the one hand, and a mother liquor I′ on the other hand. The mother liquor I′ comprises lithium hydroxide (the mass concentration of which is preferably between 6% and 10%) and sodium sulfate (the mass concentration of which is preferably between 10% and 16%). The mass concentrations calculated with respect to the total mass of the mother liquor I′.

The solid LiOH salt obtained after the crystallisation step by evaporation c′) 30′ is impure. Advantageously, in order to purify it, at least a part of this LiOH salt is dissolved in demineralised water in an aqueous dissolution step d′) in order to form an aqueous composition (C′) comprising a LiOH salt. In particular, the quantity of water added is a function of the solubility threshold of LiOH, the quantity of LiOH must remain less than its solubility threshold in order to avoid a precipitation/agglomeration of the LiOH in solution. The aqueous composition (C′) thus preferably comprises approximately 6% by mass of LiOH at approximately 35° C. This aqueous composition (C′) then undergoes a second crystallisation step by evaporation e′) 50′, in particular the aqueous composition (C′) is heated to between 30° C. and 110° C., in particular to approximately 60° C. This step e′) 50 enables the formation of a solid LiOH monohydrate salt and a mother liquor II′ comprising lithium hydroxide (the mass concentration of which is preferably between 13% and 16%) and sodium sulfate (the mass concentration of which is preferably less than 2%). Step 50′ can be followed by a drying step f′) 60′, for example at a heating temperature of order 50° C., until a dry purified lithium hydroxide monohydrate salt (LiOH, H₂O) is produced.

The mother liquor II′ resulting from step e′) 50′, being weakly loaded with sulfates and rich in LiOH, can be recycled by being supplied to the first crystallisation step c′) by evaporation 30′, optionally mixed with at least a part of the mother liquor III′. The second crystallisation step by evaporation e′) 50′ makes it possible to obtain, in particular after drying f′) 60′, high-purity LiOH monohydrate crystals that are suitable, for example, for the grades required for the manufacture of batteries.

The mother liquor I′ coming from the first crystallisation by evaporation c′) 30′ can be advantageously recycled by being supplied, at least in part, to the first crystallisation by cooling c) 80′. Indeed, the mother liquor I′ at the outlet of step c′) 30′, having been heated, is at a temperature of order approximately 60° C.-70° C. This calorific energy is thus used in step c) 80′ to produce a mother liquor III′ comprising lithium hydroxide (the mass concentration of which is preferably between 6% and 10%) and sodium sulfate (the mass concentration of which is preferably between 10% and 16%) and to crystallise the sodium sulfate. This mother liquor III′ being rich in lithium hydroxide can advantageously be recycled during the first crystallisation by evaporation c′) 30′, optionally by being mixed, at least in part, with the mother liquor II′. Step c) 80′ also makes it possible to produce a sodium sulfate salt, in particular a Glauber's salt (Na₂SO₄, 10H₂O). At least part of the Glauber's salt obtained in step c) 80′ is dissolved in water, in particular distilled water, during a dissolution step h′) 90′, preferably at a mass concentration ranging from 20% to 30%, for example of order 27%-28% at 35° C. Preferably, the mass concentration of sodium sulfate in the produced aqueous composition (D′) is determined so as to remain below the solubility threshold thereof. The aqueous composition (D′) comprising the dissolved Glauber's salt can then advantageously undergo a crystallisation step by evaporation i′) 100 during which the composition (D′) is heated, in particular to a temperature ranging from approximately 50° C. to approximately 110° C., for example to approximately 80° C. This step i′) 100′ can be followed by a drying step k′) 120′, in particular at a temperature of 80-90° C. The salt obtained is preferably an anhydrous sodium sulfate salt. This crystallisation step by evaporation i′) 100′ enables the formation of a mother liquor IV′ comprising lithium hydroxide (the mass concentration of which is preferably less than or equal to 2%) and sodium sulfate (the mass concentration of which is preferably between 25% and 35%, for example of order 30%). The mother liquor IV′ can be recycled in the crystallisation step by cooling c) 80′, optionally mixed with the mother liquor I′.

In particular, step c′) 30′ of the third method example corresponds to step c) 30 of the first and second method examples but is applied to the mother liquor (III′) coming from the crystallisation step c) 80′, and not directly to the aqueous composition (B).

The third method example, just as the first method example, enables the manufacture of an anhydrous and pure sodium sulfate salt via a crystallisation step by evaporation i) 100 for the first method example or a crystallisation step by evaporation i′) 100′ for the third method example.

The fourth method example shown in FIG. 4 is a variant of the third method example, and applies, for example, when the mass concentration of sodium ions is greater than the mass concentration of lithium ions so that after step b), a crystallisation step c) 80′ is carried out, but of the sodium sulfate salt, and this by cooling, in order to produce a mother liquor III′ in which the mass concentration of lithium ions is increased and can then undergo a crystallisation step by evaporation c′) 30′.

The fourth method example is similar to the third method example with the difference that the aqueous composition (D′) undergoes a bipolar membrane electrodialysis step (BPED2) j′) 110′ and not a crystallisation step i′).

The fourth method example, just as the second method example, makes it possible to produce acid and base solutions via a bipolar membrane electrodialysis step j) 110 for the second method example, and j′) 110′ for the fourth method example.

The bipolar membrane electrodialysis steps (BPED1) and (BPED2) in the second and fourth method examples shown respectively in FIGS. 2 and 4 are carried out as described with reference to the first method example shown in FIG. 1 for BPED1 and to the second method example shown in FIG. 2 for BPED2 with the support of FIGS. 5 and 6. Similarly, the bipolar membrane electrodialysis step (BPED1) of the third method example is carried out as described with reference to the first method example shown in FIG. 1 with the support of FIG. 5.

The mass concentrations indicated with respect to a mother liquor (I, II, III and IV, I′, II′, III′, IV′) correspond to the mass of a given compound with respect to the total mass of the mother liquor (therefore including water).

### Description of Examples of Preparation of an Aqueous Composition (B)

An aqueous composition (A) comprising a mass concentration of a mixture of Li₂SO₄ and Na₂SO₄ of 10% (measured with respect to the total of the aqueous composition (A)), with an equal mass proportion between Li and Na, was processed in an electrodialyser designed to carry out step a) (BPED1) and comprising approximately 7 cells similar to the cell 200 shown in FIG. 5 in order to convert lithium sulfate into lithium hydroxide.

Tests 1 to 3 were performed at a fixed current of 17 A (amperes) and with a free voltage. The acid concentrations were variable in the first compartment, the concentration of H₂SO₄ in the first compartment 220 was held constant at 2% for test 1, at 6% for test 2, and at 8% for test 3, by continuous make-up of water. The electrolyte H₂SO₄ is 1N (i.e., 0.5 mol/L). The initial pH of the composition (A) in the 3 tests was variable between 6 and 10 in order to simulate the range of pH of different compositions (A).

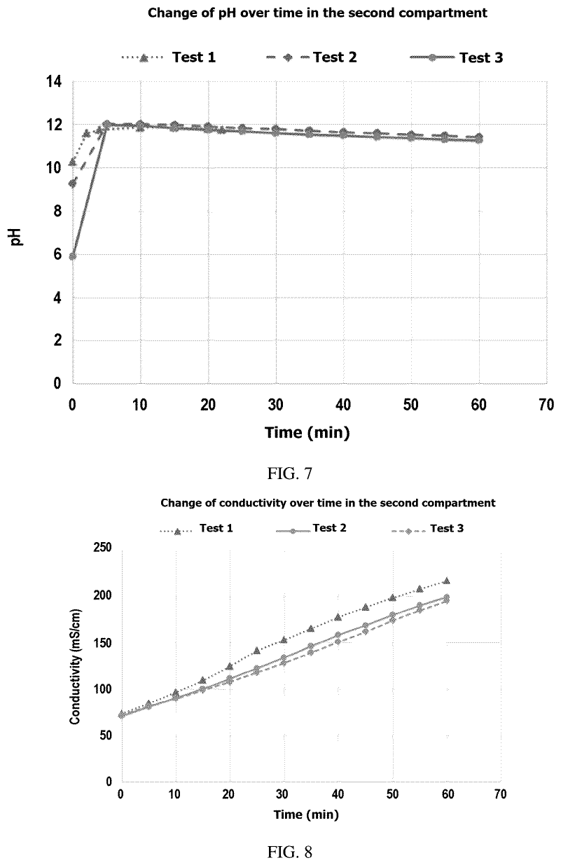

In FIG. 7, it can be seen that whatever the starting pH, during the course of the electrodialysis (BPED1, step a)) the pH increases very rapidly in the second compartment 210 and stabilises at approximately 11.9.

In FIG. 8, it can be seen that the conductivity increases linearly in the second compartment 210 for each test in order to reach 200 mS/cm. The OH⁻ ions replace the sulfate ions to form LiOH which is more conductive than Na₂SO₄

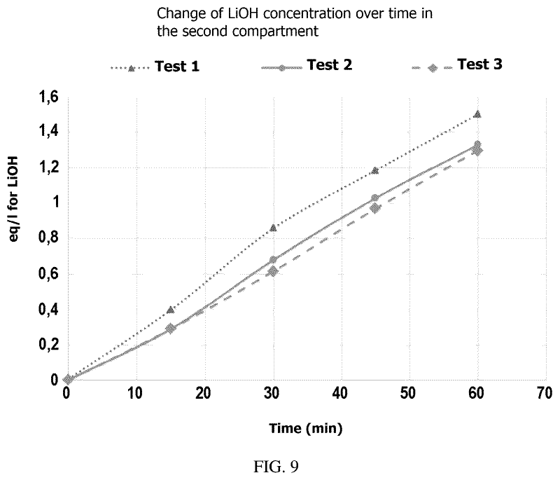

In FIG. 9, the quantity of LiOH produced over time in composition B is measured. A conversion of Li₂SO₄ into LiOH is obtained at the end of 60 minutes for each test: 100% conversion for test 1, approximately 88% for test 2, and approximately 86% for test 3. Is also observed that the conversion yield is affected by the sulfuric acid concentration of compartment 1.

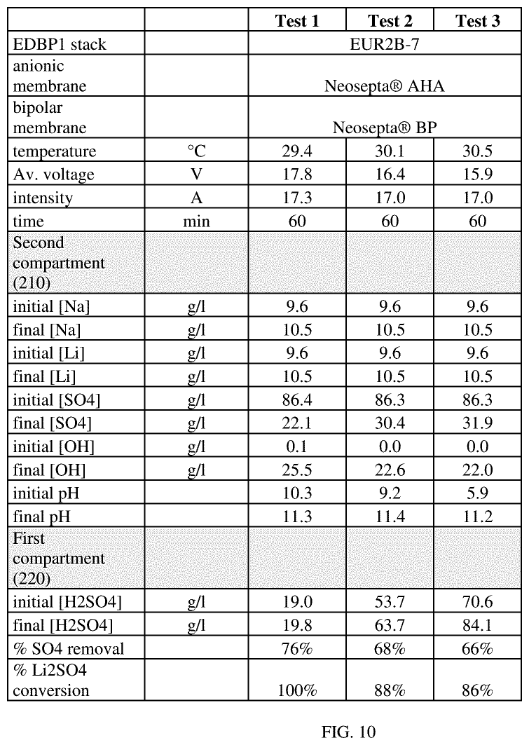

The table in FIG. 10 shows the different initial and final concentrations of Li, Na, OH, SO₄ in the second compartment of EDBP1, the initial or final concentration of sulphuric acid in the first compartment of EDBP1, and the conditions of use for tests 1 to 3.

In this specific example, tests 1 to 3 are carried out on Eurodia's EUR2B-7 pilot electrodialyser.

The method for preparing lithium hydroxide according to the invention makes it possible to convert Li₂SO₄ into LiOH in a quick and reliable manner, and to advantageously prepare a composition B, comprising a mixture of LiOH with Na₂SO₄, which can be processed during a crystallisation step:
either by evaporation in order to form high-purity lithium hydroxide monohydrate and mother liquors which can be recycled in order to recover the lithium in the form of lithium hydroxide and to recover sodium sulfate in the form of Glauber's salt or anhydrous salt,
or by cooling in order to recover a Glauber's salt and to produce a mother liquor concentrated in lithium capable of following the chain of crystallisation by evaporation.

In examples 1 to 3, the mass ratio Li/Na is greater than 1 (i.e., Li>Na) so that the pathway by evaporation would be favoured, preferably corresponding to the method illustrated in FIG. 1 or 2.

The method according to the invention enables energy savings in the production of lithium hydroxide (for example by carrying out an evaporation by cooling, on a liqueur coming from a crystallisation by evaporation) and production of a high-purity lithium hydroxide salt, and this by recovering the lithium as much as possible and doing so without generating non-recoverable by-products, as is the case in the prior art with calcium carbonate. In the method according to the invention, the by-products are recoverable because they can be reused: in acid, in base or in sodium sulfate based salt (in particular in Glauber's salt or in sodium sulfate salt monohydrate).

1. A method for preparing lithium hydroxide, wherein said method comprises the steps:
a) subjecting an aqueous composition (A) comprising lithium sulfate and sodium sulfate, to a bipolar membrane electrodialysis (BPED1) in order to convert at least a part, or substantially all, of the lithium sulfate into lithium hydroxide;
said step a) of bipolar membrane electrodialysis (BPED1) comprising processing in an electrodialyser comprising at least one electrodialysis cell, said electrodialysis cell comprising:
a first compartment in which water is supplied, between a first bipolar membrane and an anionic membrane, in particular an anionic central membrane, and
a second compartment in which said aqueous composition (A) comprising lithium sulfate and sodium sulfate is supplied, between an anionic membrane, and a second bipolar membrane,
b) recovering an aqueous composition (B) comprising lithium hydroxide and sodium sulfate at the outlet of the second compartment of said at least one electrodialysis cell,
c) subjecting at least a part of the aqueous composition (B) comprising lithium hydroxide and sodium sulfate to a crystallisation step c) of a salt.

2. The method according to claim 1, wherein the crystallisation step c) of a salt is a crystallisation step, of a lithium hydroxide salt in order to obtain a lithium hydroxide salt on the one hand, and a mother liquor (I) comprising sodium sulfate and lithium hydroxide on the other hand.

1. A method for preparing lithium hydroxide, wherein said method comprises the steps:
a) subjecting an aqueous composition (A) comprising lithium sulfate and sodium sulfate, to a bipolar membrane electrodialysis (BPED1) in order to convert at least a part, or substantially all, of the lithium sulfate into lithium hydroxide;
said step a) of bipolar membrane electrodialysis (BPED1) comprising processing in an electrodialyser comprising at least one electrodialysis cell, said electrodialysis cell comprising:
a first compartment in which water is supplied, between a first bipolar membrane and an anionic membrane, and
a second compartment in which said aqueous composition (A) comprising lithium sulfate and sodium sulfate is supplied, between an anionic membrane, and a second bipolar membrane,
b) recovering an aqueous composition (B) comprising lithium hydroxide and sodium sulfate at the outlet of the second compartment of said at least one electrodialysis cell,
c) subjecting at least a part of the aqueous composition (B) comprising lithium hydroxide and sodium sulfate to a crystallisation step c) of a salt (30, 80′).

2. The method according to claim 1, wherein the crystallisation step c) of a salt is a crystallisation step, of a lithium hydroxide salt in order to obtain a lithium hydroxide salt on the one hand, and a mother liquor (I) comprising sodium sulfate and lithium hydroxide on the other hand.

3. The method according to claim 1, wherein the crystallisation step c) of a salt is a crystallisation step of a sodium sulfate salt (Na₂SO₄) in order to obtain a Glauber's salt on the one hand, and a mother liquor (III′) comprising lithium hydroxide and sodium sulfate on the other hand.

4. The method according to claim 2, wherein said method comprises a step d) of dissolving at least a part of the lithium hydroxide salt obtained in step c), in order to form an aqueous composition (C) comprising said dissolved lithium hydroxide salt, and wherein said method comprises a crystallisation step e) of at least a part of the aqueous composition (C) in order to obtain lithium hydroxide crystals.

5. The method according to claim 2, wherein said method comprises a crystallisation step g) of at least a part of the mother liquor (I) obtained in the crystallisation step c) in order to obtain a Glauber's salt and a mother liquor (III) comprising sodium sulfate and lithium hydroxide.

6. The method according to claim 3, wherein said method comprises:
a step h) or h′) of dissolving all or part of the Glauber's salt so as to form an aqueous composition (D) or (D′) comprising sodium sulfate, and
processing j) or j′) at least a part of said aqueous composition (D) or (D′) comprising sodium sulfate by bipolar membrane electrodialysis (BPED2), in order to extract sulfate ions, on the one hand, and to form sulfuric acid and extract sodium ions on the other hand and to form sodium hydroxide.

7. The method according to claim 3, wherein said method comprises:
a step of preparing an aqueous composition (D) or (D′) from all or part of the Glauber's salt, and
a crystallisation step i) or i′) of at least a part of said aqueous composition (D) or (D′) comprising sodium sulfate, in order to obtain an anhydrous sodium sulfate salt and a mother liquor IV) or IV′) comprising sodium sulfate.

8. The method according to claim 3, wherein at least a part of the mother liquor (III) or (III′) obtained in the crystallisation step g) or c) of the sodium sulfate (Na₂SO₄), undergoes a crystallisation step of lithium hydroxide (LiOH).

9. The method according to claim 3, wherein at least a part of the mother liquor (III′) obtained in the crystallisation step c) of the sodium sulfate (Na₂SO₄) undergoes a crystallisation step c′) of lithium hydroxide (LiOH), wherein said method further comprises a step d′) of dissolving at least a part of the lithium hydroxide salt obtained in step c′) in order to form an aqueous composition (C′) comprising said dissolved lithium hydroxide salt, and wherein said method comprises a crystallisation step e′) of at least a part of the aqueous composition (C′) in order to obtain lithium hydroxide crystals.

10. The method according to claim 78, wherein at least a part of the mother liquor (IV) or (IV′) obtained in the crystallisation step i) or i′) of at least a part of the aqueous composition (D) or (D′), undergoes a crystallisation step g) or c).

11. The method according to claim 1, wherein the mass ratio of lithium ions and sodium ions over the total mass of cations in the aqueous composition (A), comprising lithium sulfate and sodium sulfate and supplied at the inlet of the second compartment of said at least one electrodialysis cell of the bipolar membrane electrodialyser (BPED1) in step a), is greater than or equal to 95%, and wherein the mass ratio between the lithium ions and the sodium ions (Li/Na) in said composition (A) is greater than or equal to 0.1 and less than or equal to 9.

12. The method according to claim 1, wherein the aqueous composition (A), comprising lithium sulfate and sodium sulfate supplied at the inlet of the second compartment of said at least one electrodialysis cell of the bipolar membrane electrodialyser (BPED1) in step a), has a pH greater than or equal to 4 and less than or equal to 10.

13. The method according to claim 1, wherein the aqueous composition (B), comprising lithium hydroxide and sodium sulfate at the outlet of the second compartment of said at least one electrodialysis cell of the bipolar membrane electrodialyser (BPED1) in step a), has a pH greater than or equal to 9.

14. The method according to claim 1, wherein the aqueous composition at the outlet of the first compartment of said at least one electrodialysis cell of the bipolar membrane electrodialyser (BPED1) in step a) comprises sulfuric acid.

15. A manufacturing method according to claim 1, wherein the aqueous composition (A) comprising lithium sulfate and sodium sulfate supplied at the inlet of the second compartment of said at least one electrodialysis cell of the bipolar membrane electrodialyser (BPED1) during step (a) has undergone a prior treatment to extract divalent cations.

16. Facility for implementing the method for preparing lithium hydroxide according to claim 1, wherein said facility comprises:
a) an electrodialyser (BPED1) comprising:
at least one cell comprising:
a first bipolar membrane and an anionic membrane delimiting therebetween, a first compartment having an inlet for the intake of water and an outlet for the discharge of an aqueous composition comprising sulfuric acid, and
a second bipolar membrane delimiting with an anionic membrane a second compartment having an inlet for the intake of an aqueous composition (A) comprising lithium sulfate and sodium sulfate and an outlet for the discharge of an aqueous composition (B) comprising sodium sulfate and lithium hydroxide,
b) a crystallisation unit of a salt, said salt crystallisation unit comprising an inlet for intake of at least a part of the aqueous composition (B) comprising sodium sulfate and lithium hydroxide, said at least one part of the composition (B) coming from the second compartment of said at least one cell of the electrodialyser (BPED1).

17. A facility according to claim 16, wherein:
the salt crystallisation unit c) is a unit for crystallising lithium hydroxide, comprising an inlet for the intake of at least a part of the aqueous composition (B) comprising sodium sulfate and lithium hydroxide coming from the second compartment of said at least one cell of the electrodialyser (BPED1), and a first outlet for the discharge of solid lithium hydroxide and a second outlet for the discharge of a mother liquor (I) comprising sodium sulfate and lithium hydroxide.

18. The facility according to claim 16, wherein:
the salt crystallisation unit c) is a unit for crystallising sodium sulfate, comprising an inlet for the intake of at least a part of the aqueous composition (B) comprising sodium sulfate and lithium hydroxide coming from the second compartment of said at least one cell of the electrodialyser (BPED1), and a first outlet for the discharge of solid sodium sulfate and a second outlet for the discharge of a mother liquor (III′) comprising sodium sulfate and lithium hydroxide.

19. The facility according to claim 17, wherein said facility comprises:
a unit d) for dissolving at least a part of the lithium hydroxide salt coming from the crystallisation unit c) in order to form an aqueous composition (C) comprising said dissolved lithium hydroxide salt, and
a crystallisation unit e), comprising an inlet for the intake of at least a part of the aqueous composition (C), and a first outlet for the discharge of lithium hydroxide crystals, and a second outlet for the discharge of a mother liquor (II).

20. The facility according to one claim 17, characterised in that said facility comprises:
a crystallisation unit g) comprising an inlet for the intake of at least a part of the mother liquor (I) coming from the crystallisation unit c), and a first outlet for the discharge of a sodium sulfate salt, as well as a second outlet for the discharge of a mother liquor (III) comprising sodium sulfate and lithium hydroxide.

21. The facility according to claim 18, wherein said facility comprises:
a unit h) or h′) for dissolving at least a part of the sodium sulfate salt in order to form an aqueous composition (D) or (D′) comprising sodium sulfate,
a bipolar membrane electrodialyser (BPED2) for processing j) or j′), comprising an inlet for the intake of at least a part of said aqueous composition (D) or (D′) comprising sodium sulfate, and a first outlet for the discharge of sulfuric acid, and a second outlet for the discharge of sodium hydroxide.

22. The facility according to claim 18, wherein said facility comprises:
a unit h) or h′) for preparing an aqueous composition (D) or (D′) from at least a part of the sodium sulfate salt, and
a crystallisation unit i) or i′) comprising an inlet for the intake of at least a part of said aqueous composition (D) or (D′) comprising sodium sulfate, and a first outlet for the discharge of a sodium sulfate salt and a second outlet for the discharge of a mother liquor (IV) or (IV′) comprising sodium sulfate.

23. The facility according to claim 18, wherein said facility comprises:
a unit for conveying at least a part of the mother liquor (III) or (III′) coming from the crystallisation unit g) or c) by cooling, to the crystallisation unit c) or a crystallisation unit c′), said crystallisation unit c) or c′) comprises a first outlet for the discharge of lithium hydroxide and a second outlet for the discharge of the mother liquor (I) or a mother liquor (I′).

24. The facility according to claim 23, wherein said facility comprises:
a unit d′) for dissolving at least a part of the lithium hydroxide salt coming from the crystallisation unit c′) in order to form an aqueous composition (C′) comprising said dissolved lithium hydroxide salt, and
a crystallisation unit e′) comprising an inlet for the intake of at least a part of the aqueous composition (C′), and a first outlet for the discharge of lithium hydroxide crystals, and a second outlet for the discharge of a mother liquor (II′).

25. The facility according to claim 22, wherein said facility comprises a unit for conveying at least a part of the mother liquor (IV) or (IV′) coming from the crystallisation unit i) or i′), to the crystallisation unit c) or g).

26. The method according to claim 5, wherein said method comprises:
a step h) or h′) of dissolving all or part of the Glauber's salt so as to form an aqueous composition (D) or (D′) comprising sodium sulfate, and
processing j) or j′) at least a part of said aqueous composition (D) or (D′) comprising sodium sulfate by bipolar membrane electrodialysis (BPED2), in order to extract sulfate ions, on the one hand, and to form sulfuric acid and extract sodium ions on the other hand and to form sodium hydroxide.

27. The method according to claim 5, wherein said method comprises:
a step of preparing an aqueous composition (D) or (D′) from all or part of the Glauber's salt, and
a crystallisation step i) or i′) of at least a part of said aqueous composition (D) or (D′) comprising sodium sulfate, in order to obtain an anhydrous sodium sulfate salt and a mother liquor IV) or IV′) comprising sodium sulfate.

28. The method according to claim 5, wherein at least a part of the mother liquor (III) or (III′) obtained in the crystallisation step g) or c) of the sodium sulfate (Na₂SO₄), undergoes a crystallisation step of lithium hydroxide (LiOH).
